(19) United States
(12) Patent Application Publication
(10) Pub. No.: US 2010/0034445 A1
(43) Pub. Date: Feb. 11, 2010

(54) Continuous imaging of nucleic acids

(75) Inventor: Kevin Ulmer, Cohasset, MA (US)

Correspondence Address: COOLEY GODWARD KRONISH LLP;ATTN: Patent Group, Suite 1100, 777 - 6th Street, NW, WASHINGTON, DC, 20001, US

(73) Assignee: Genome Corporation, Cohasset, MA (US)

(21) Appl. No.: 12/221,793

(22) Filed: Aug. 6, 2008

(51) Int. Cl. G06K 9/00; G01N 27/27

(52) U.S. Cl. 382/129; 204/612; 204/461

(57) ABSTRACT

The present invention relates to devices, systems, and methods for continuous imaging of nucleic acids. In one embodiment, the invention herein generally relates to a device for continuously imaging nucleic acids, the device including a rotating drum in which an exterior surface of the drum includes a plurality of color sensitive pixels.

### TECHNICAL FIELD

The present invention relates to devices, systems, and methods for continuous imaging of nucleic acids.

### BACKGROUND

DNA sequencing has generally been accomplished by Sanger sequencing. In Sanger sequencing, dideoxynucleotide terminated and labeled DNA fragments are synthesized, denatured, and then separated by size using gel electrophoresis on a denaturing polyacrylamide-urea gel capable of resolving single-base differences in chain length. DNA bands are then visualized by autoradiography, chemiluminescence or fluorescence, depending on the labeling method, and the DNA sequence can be directly read from a film or digitally recorded gel image.

A variety of non-Sanger sequencing methods have recently been developed, most of them exploiting advances in single DNA molecule amplification. For example, one such single-molecule DNA sequencing technique uses emulsion PCR to amplify single DNA molecules attached to the surface of microscopic beads followed by pyrosequencing. In pyrosequencing, bioluminescence from a luciferin:luciferase reaction is detected by real-time imaging of arrays of beads with a CCD detector. Another single-molecule DNA sequencing technique uses cluster amplification of single molecules attached to a surface followed by sequencing by synthesis using cleavable fluorescent labels and reversible terminators attached to the nucleotide. The method requires alternating cycles of single base addition and imaging, resulting in very short reads (about 25-50 bases). Yet another method uses a variant of emulsion PCR, followed by sequencing by ligation, which also requires alternating cycles of ligation and imaging. In one direct single molecule sequencing method that does not require amplification, DNA molecules are attached to the surface of a flow cell and the fluorescence of single polymerase incorporated nucleotides is excited by the evanescent wave of Total Internal Reflection Fluorescence (TIRF) and imaged with a CCD camera, also requiring alternating cycles of single base addition and imaging. In yet another direct single molecule sequencing method, the incorporation of single, gamma-phosphate labeled fluorescent nucleotides by single immobilized DNA polymerase molecules is imaged in real time through Zero Mode Wave Guides.

Both Sanger sequencing techniques and these various “single-molecule” DNA sequencing techniques involve an imaging step, which is a significant limitation to DNA sequencing throughput. In current automated or semi-automated Sanger sequencing instruments, whether slab gels, capillaries or microchips are used, real-time detection of fluorescence occurs as bands pass a detector during electrophoresis. As a result, current Sanger sequencing instruments suffer from poor utilization of the relatively expensive detection system, i.e., inefficient duty cycle. Further, throughput is also limited by the number of pixels of raw data that must be collected and processed for each “called” base in a read. For Sanger based methods, each peak in an electropherogram, corresponding to a single base, requires about 10 pixels to define its shape and position.

Similarly, throughput in single-molecule DNA sequencing is limited by the number of pixels of raw data that must be collected and processed for each “called” base in a read. For single-molecule DNA sequencing methods, individual objects corresponding to beads, clusters, or single-molecules must be resolved and centroids calculated, and a similar number of pixels per object is typically required (e.g., a 3 by 3 pixel box which is about 9 pixels). However, depending on the distribution of the objects to be imaged, there may be an overhead of significant additional pixels.

There is a need for devices, systems, and methods that can more rapidly image hundreds of millions to many billions of individual base reads at significantly lower costs and higher throughput than prior art imaging techniques.

### SUMMARY

The invention herein provides systems, methods, and devices, for more efficiently imaging nucleic acids and increasing throughput of DNA sequencing. The systems and devices herein, combined with peroxyoxalate chemiluminescent chemistry (POCL) excitation of appropriate dye-labeled Sanger sequencing reagents, allow for large areas of sequencing gel to be rapidly, efficiently, and continuously imaged resulting in higher sequencing throughput than prior art techniques and systems. No fluorescence excitation sources are required, i.e., lamps, lasers, LEDs, and no imaging optics or focusing system are needed, eliminating associated cost and complexity. Detection efficiency is maximized by direct contact imaging combined with the high signal-to-background of POCL, and color multiplexing is possible because of the broad excitation capabilities of the POCL chemistry combined with the color-sensitive pixel architecture. Further, the imaging device includes minimal moving parts, avoiding cost and complexity associated with step-and-repeat imaging systems.

An aspect of the invention herein provides a device for continuous imaging of nucleic acids, the device includes: a rotating drum, in which an exterior surface of the drum includes a plurality of color sensitive pixels. In one embodiment, each pixel includes at least one photodiode and at least one thin film transistor. The photodiodes and the thin film transistors can be made from semiconducting polymers, for example, and/or amorphous silicon. In certain embodiments, the imaging device further includes readout circuitry connected to the pixels by at least one electrode.

Each pixel on the exterior surface of the drum is capable of detecting colors within the visible and infrared light spectrum, for example, at least four different colors within the visible and infrared light spectrum, at least eight different colors within the visible and infrared light spectrum, or at least about sixteen different colors within the visible and infrared light spectrum.

Another aspect of the invention herein provides a system for continuous imaging of nucleic acids, the system including: a conveyance apparatus for conveying an electrophoresis gel containing nucleic acids along a conveying path; a device that removes a first top film from the electrophoresis gel, exposing a top surface of the electrophoresis gel; at least one fixing reservoir connected to the conveyance apparatus, in which the fixing reservoir is configured such that fixing solutions are in fluid contact with the electrophoresis gel being conveyed along the conveying path; a dryer device connected to the conveyance apparatus; a coating apparatus that applies peroxyoxalate chemiluminescent chemistry reagents and a second top film to the exposed top surface of the electrophoresis gel; and an imager connected to the conveyance apparatus including a rotating drum, in which an exterior surface of the drum includes a plurality of color sensitive pixels, in which the imager is configured such that the second top film of the electrophoresis gel is in contact, such as direct contact, with the color sensitive pixels as the electrophoresis gel is being conveyed along the conveying path.

The coating apparatus can include a first horizontally oriented roller and a second horizontally oriented roller, in which the second roller is located above the first roller, in which the first and second rollers are configured such that a precision slot is formed between the rollers, such that a bottom surface of the electrophoresis gel is conveyed over the first roller, and such that the second roller applies the second top film to the exposed top surface of the electrophoresis gel; in which the apparatus further includes a distribution channel connected to a reservoir, and at least one pump that dispenses premixed peroxyoxalate chemiluminescent chemistry reagents onto the exposed top surface of the electrophoresis gel prior to the electrophoresis gel reaching the slot between the rollers where the second top film is applied. The coating apparatus can further include a feeder unit with a roll support frame for supporting a continuous roll of the second top film, in which the feeder unit is connected to the coating apparatus.

Alternatively, the coating apparatus can include a plurality of printing apparatuses and laminating apparatuses, in which a first printing apparatus applies a first component of peroxyoxalate chemiluminescent chemistry reagents to the exposed top surface of the electrophoresis gel, a second printing apparatus applies a second component of peroxyoxalate chemiluminescent chemistry just prior to the lamination of the second top film onto the exposed top surface of the electrophoresis gel, and at least one laminating apparatus applies the second top film to the exposed top surface of the electrophoresis gel.

Such an apparatus may alternatively employ spray coating nozzles and methods to apply the peroxyoxalate chemiluminescent chemistry as premixed or separate components immediately prior to applying the second top film.

In certain embodiments, the system further includes at least one computer operably connected to the continuous imaging system. The fixing reservoir of the system can further include a recirculation pump, an inlet reservoir connected to an inlet valve of the fixing reservoir, and a waste reservoir connected to an outlet valve of the fixing reservoir. Exemplary fixing solutions include acetic acid, propionic acid, succinic acid, tartaric acid, citric acid, methanol, ethanol, n-propanol, isopropanol, iso-butyl alcohol, sec-butyl alcohol and tert-butyl alcohol.

The system of the invention uses peroxyoxalate chemiluminescent chemistry reagents for exciting fluorescent labels attached to the nucleic acids. Peroxyoxalate chemiluminescent chemistry reagents include at least a saturated oxalate solution and a concentrated hydrogen peroxide solution. Imaging of the fluorescently labeled nucleic acids is accomplished using the imaging device described above.

Another aspect of the invention herein provides a method for continuously imaging nucleic acids, the method including: removing a first top film of an electrophoresis gel containing the nucleic acids, exposing a top surface of the electrophoresis gel, as the electrophoresis gel is being conveyed along a conveying path; fixing the nucleic acids and drying the electrophoresis gel; applying peroxyoxalate chemiluminescent chemistry reagents and a second top film to the exposed top surface of the electrophoresis gel; and imaging the nucleic acids.

The peroxyoxalate chemiluminescent chemistry reagents and the second top film are applied to the exposed top surface of the electrophoresis gel by the coating apparatuses described above. Fixing the nucleic acids in the electrophoresis gel includes contacting the exposed top surface of the electrophoresis gel with at least one fixing solution, as the electrophoresis gel is being conveyed along the conveying path. Imaging the nucleic acids is accomplished by the systems and devices described above.

Another aspect of the invention herein provides a method of sequencing DNA, including: conducting a sequencing reaction in a microcapsule; applying the microcapsule and a first polymer matrix onto a base film to form an electrophoresis gel that is being continuously conveyed along a conveying path; conducting electrophoretic separation; and imaging the nucleic acids, in which imaging includes contacting a top film of the electrophoresis gel to an exterior surface of a rotating drum, in which the exterior surface of the drum includes a plurality of color sensitive pixels.

Another aspect of the invention herein provides a device for continuous imaging of nucleic acids, the device including: a rotating drum, in which an exterior surface of the drum includes a plurality of slits and a plurality of color sensitive pixels, in which an interior of the drum includes at least one light source configured to emit light through the slits in the exterior surface of the drum. The imaging device can further include at least one light source connected to each edge of the rotating drum. Exemplary light sources include a lamp, a laser, and an LED.

In one embodiment, each pixel includes at least one photodiode and at least one thin film transistor. The photodiodes and the thin film transistors can be made from semiconducting polymers, for example, and/or amorphous silicon. In certain embodiments, the imaging device further includes readout circuitry connected to the pixels by at least one electrode. Each pixel on the exterior surface of the drum is capable of detecting colors within the visible and infrared light spectrum, for example, at least four different colors within the visible and infrared light spectrum, at least eight different colors within the visible and infrared light spectrum, or at least about sixteen different colors within the visible and infrared light spectrum.

### BRIEF DESCRIPTION OF THE DRAWINGS

FIG. 1 is a drawing showing an embodiment of a system for continuously imaging nucleic acids.

FIG. 2 is a diagram of a multiple sheath flow device that can be used to make the microcapsules of the present invention.

FIGS. 3A and 3B are bright field and fluorescent images, respectively, of impermeable polymer shell microcapsules 6 days post-encapsulation.

FIG. 4 is a bright field image of smaller diameter impermeable polymer shell microcapsules.

FIGS. 5A-L are bright field and fluorescent images of intermediate diameter and/or thinner impermeable polymer shell microcapsules.

FIGS. 6A-D are bright field and fluorescent images of permeable polymer shell microcapsules at 5 minutes and 20 hours post-encapsulation.

FIGS. 7A-T are bright field and fluorescent images of semi-permeable polymer shell microcapsules at 5 minutes and 16 hours post encapsulation.

FIGS. 8A-F are bright field and fluorescent images of higher molecular weight cut-off semi-permeable polymer shell microcapsules.

FIG. 9A-H are bright field and fluorescent images of semi-permeable polymer shell microcapsules containing DNA.

FIG. 10A-L are bright field and fluorescent images of semi-permeable polymer shell microcapsules used for Rolling Circle Amplification of encapsulated DNA.

FIG. 11A-L are bright field and fluorescent images of Rolling Circle Amplification in alternative formulation semi-permeable polymer shell microcapsules.

FIG. 12A-D are bright field and fluorescent images demonstrating thermostability of semi-permeable polymer shell microcapsules.

FIG. 13A-F are bright field and fluorescent images demonstrating permeability of polymer shell microcapsules to dye-labeled dideoxyterminators.

### DETAILED DESCRIPTION

Prior art DNA sequencing systems and methods are limited in throughput because of the capability of imaging devices and the imaging step involved in sequencing methods. The invention herein provides devices, systems, and methods for continuously imaging nucleic acids that increase DNA sequencing throughput and overcome problems with prior art techniques. For example, the methods herein utilize fluorescent labels, which provide the largest signal of available labeling methods, e.g., equal to or greater than one million emitted photons per fluorophore, while simultaneously offering a broad range of emission wavelengths for multicolor imaging. Use of fluorescent labels allows for, for example, four color imaging (adequate for conventional Sanger sequencing and some of the newer “single-molecule” methods), eight color imaging (mate-pairs), and even sixteen color imaging (complementary sequences of mate-pairs).

Further, the devices, systems, and methods herein take advantage of chemiluminescent excitation of the fluorophores, rather than conventional laser, lamp or LED excitation of fluorescence, eliminating costs and complexities associated with excitation optics, while also eliminating resulting sources of background, e.g., Rayleigh and Raman scattering, fluorescence of optical components, filter leakage, etc. Additionally, chemiluminescent excitation simplifies multicolor imaging, for example imaging that involves more than four colors, avoiding the need for multiple excitation sources and/or complex energy transfer dyes.

The devices and systems for imaging a nucleic acid further include components that increase DNA sequencing throughput and overcome problems with prior art systems. For example, the devices and systems herein use contact imaging, for example, direct contact imaging, and direct digitization. Contact imaging eliminates the need for lenses or other optical elements interposed between the sample and the detector, while providing very high photon collection efficiency. No automated focusing system is required. Direct digitization by the imaging devices and systems herein avoids the need for a separate scanning and digitization step as required, for example, when using photographic film to record the electropherogram from an isotopically or chemiluminescently labeled slab gel.

Further, utilization of single-pixel, multi-color detection eliminates the need for sequential, multiple-pass, monochromatic detection of individual colors, or the losses associated with the use of Bayer filters, or similar color filter arrays, in which individual pixels can only detect a single color. Large area detectors avoid the mechanical complexities of step-and-repeat imaging with small area sensors, while greatly increasing throughput.

The foregoing and other objects, features, and advantages of the invention will become apparent from the following, more particular description of certain embodiments according to the invention and accompanying drawing.

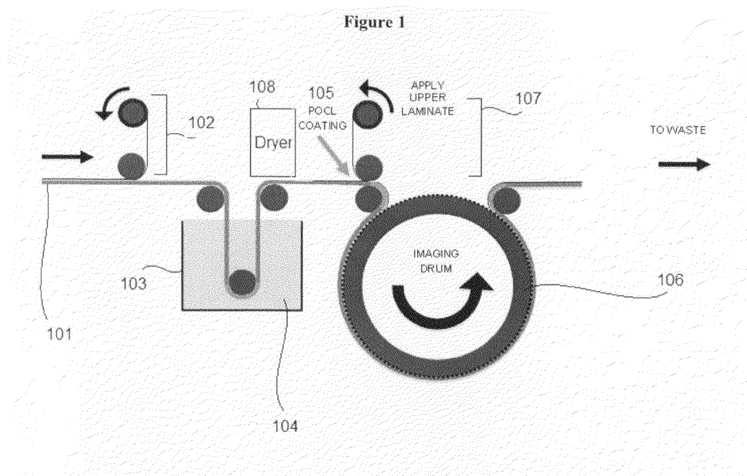

FIG. 1 shows a system of the invention for imaging nucleic acids that includes a conveyance apparatus for conveying an electrophoresis gel 101 containing the nucleic acids along a conveying path. Suitable conveyance apparatuses include a belt conveyor. In a preferred embodiment, as shown in FIG. 1, a conveyer for use in the invention comprises two or more cylindrical rotating drums, with a continuous loop of material that rotates about the drums. One or both of the drums are powered, moving the base film forward at a constant and precise speed. Additional rotating drums may be included in the conveying apparatus along with appropriate drive motors and feedback controls to insure uniform tension on the electrophoresis gel, and/or to change the direction of motion of the gel along the conveyance path. The conveyance apparatus conveys the electrophoresis gel along a conveying path such that the gel interacts with other components of the imaging system.

Systems of the invention further include a device 102 that removes a first top film from the electrophoresis gel, exposing a top surface of the electrophoresis gel. The device strips, i.e., physically and continuously delaminates, the first top film from the electrophoresis gel.

The electrophoresis gel with the exposed top surface is then conveyed by the conveying apparatus to at least one fixing reservoir 103 connected to the conveyance apparatus. The fixing reservoir 103 is configured such that fixing solutions 104 are in fluid contact with the electrophoresis gel being conveyed along the conveying path. Suitable fixing agents are well known and include, for example, alcoholic or organic acid aqueous solutions. Suitable organic acids include monobasic carboxylic acids such as acetic acid and propionic acid, dibasic acids such as succinic and tartaric acids, and tribasic acids such as citric acid. Representative alcohols that can be used include lower, i.e., C₁ to C₄ alcohols, for example, methanol, ethanol, n-propanol, isopropanol, n-, iso-, sec- or tert-butyl alcohol.

The fixing reservoir 103 can further include at least one inlet reservoir that contains a supply of a fixing solution and provides an off-line source of solution for fixing the nucleic acids in the electrophoresis gel. Thus the continuous imaging system does not need to be shutdown to refill the fixing reservoir, increasing efficiency and cycle time. In other embodiments, the continuous imaging system includes at least one waste reservoir connected to the outlet valve of the fixing reservoir. The waste reservoir receives the exhausted fixing solution from the fixing reservoir that has been used for fixing the electrophoresis gel. The waste reservoir is exchanged off-line, and thus used fixing solution is removed without disrupting the continuous process of fixing the nucleic acids in the electrophoresis gel. The fixing reservoir can further include both inlet and outlet connections to appropriate pumps for recirculation of the fixing solution to extend its useful lifetime.

In certain embodiments, the fixing reservoir is a shallow, linear trough or similar design through which the electrophoresis gel is transported by the conveying apparatus in which fixing solution covers the exposed top surface of the gel. In order to reduce the linear dimensions of the fixing reservoir, folded transport path designs may be employed, as shown in FIG. 1. In such configurations, the electrophoresis gel is transported in a serpentine pathway through the fixing reservoir, significantly reducing its horizontal length while increasing its vertical depth. Turning means for folding the transport path of the gel are well known in the art, including simple rollers or more complex designs employing non-contact turning means involving “liquid bearings” (see, for example, U.S. Pat. No. 5,353,979 entitled, “Directing apparatus for guiding, deflecting and/or diverting a web of material”; U.S. Pat. No. 5,525,751 entitled, “System for moving a submerged web”; and U.S. Pat. No. 6,991,717 entitled “Web processing method and apparatus”, all incorporated by reference herein). The transit time of the electrophoresis gel through the fixing bath can be adjusted by such means to insure adequate fixation time independent of the rate of transport of the continuously moving gel.

After fixing the nucleic acids in the electrophoresis gel, the gel is conveyed to interact with a dryer 108. The dryer 108 removes residual water from the gel and further reduces the thickness of the gel. Suitable drying technologies and methods of drying electrophoresis gels are shown in E. D. Cohen and E. B. Gutoff, eds. (1992) Modern Coating and Drying Technology, Wiley-VCH, New York.

After drying, a peroxyoxalate chemiluminescent chemistry (POCL) optimized for rapid, high-intensity light emission from the dyes used to label the DNA sequencing reactions is applied to the exposed top surface of the electrophoresis gel by a coating apparatus 105. The invention herein employs POCL chemistry because of limitations with traditional chemiluminescent procedures. Previous methods of DNA sequencing that have exploited chemiluminescent detection have utilized a restricted class of reactions in which a chemiluminescent substrate, e.g., dioxetane, acridinium ester, or luminol, is “activated”, either directly or indirectly, to a light-emitting, excited-state by a suitable enzyme, e.g., alkaline phosphatase or horseradish peroxidase. These traditional methods are essentially monochromatic in practice and suffer from a number of other deficiencies, including the indirect nature of the enzyme labeling and its associated background problems, as well as the complexity of the multistep assay.

Bioluminescence detection based on luciferin:luciferase as used in pyrosequencing suffers from many of the same limitations. While direct chemiluminescent labels, based on acridan phosphates, have recently been developed, this technology suffers from some of the same limitations as radioisotopes, such as a maximum of one photon emission per label and the monochromatic nature of the label.

Because of the organic nature of the solvent system used for POCL, this type of chemistry has had limited application for biochemical assays, which typically require aqueous solvents. The invention herein overcomes this previous limitation of POCL by fixing the nucleic acids and drying the electrophoresis gel prior to applying the POCL reagents to the exposed top surface of the gel. Since the gel is dry and the nucleic acids are fixed, miscibility and stability problems with the aqueous sequencing buffer are avoided.

In POCL systems, an oxalic acid compound is reacted with a peroxide to generate a highly-energetic, short-lived, four-membered ring dimer of CO₂ (1,2-dioxetanedione), as shown in the reaction below.

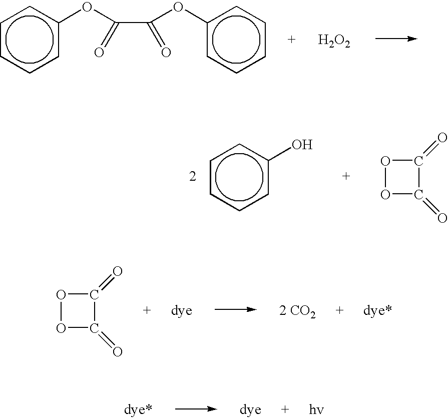

The decomposition of this dimer does not itself emit light. However, if a suitable fluorescent dye is included in the reaction, the excited state intermediate transfers its energy to the dye, resulting in fluorescent emission with very high quantum efficiency. Dyes for use in peroxyoxalate chemistry and reagents for POCL are commercially available from Sigma-Aldrich (St. Louis, Mo.).

Additives and catalysts can be included with the standard POCL reagents to increase stability and impart other properties to the chemistry. For example, additives to increase quantum yield and brightness are shown in Bollyky (U.S. Pat. No. 3,704,231). Optimized oxalates are shown in Rauhut (U.S. Pat. No. 3,749,679). Catalysts for short-lifetime and high intensity chemiluminescence are shown in Kasulin et al. (U.S. Pat. No. 3,775,336). Peroxide stable and unstable fluorescers are shown in Cranor (U.S. Pat. No. 6,267,914). Improved solvent systems for POCL are shown in Cranor (U.S. Pat. Nos. 6,126,871 and 7,052,631).

Different coating apparatuses are utilized to apply the POCL reagents. The POCL reagents can be applied sequentially by the coating apparatus, or mixed immediately before application and applied as a single component. FIG. 1 shows an embodiment that includes a coating apparatus 105. The coating apparatus 105 includes a series of dies or slots each connected through a distribution channel to a reservoir of corresponding reagent, and further includes pumps that are able to dispense the reagents in a metered fashion. The coating apparatus applies a defined amount of POCL reagents to the exposed top surface of the electrophoresis gel, and then a laminating apparatus 107 applies a second top film to the electrophoresis gel. Because the electrophoresis gel is dry, miscibility and stability problems with the POCL reagents are avoided. The second top film is transparent, for example a transparent film of polyester that is about 1 μm thick, and is applied over the POCL layer. This second top film is then brought into contact, for example direct contact, with the pixel covered surface of the imaging drum 106 and protects the imaging drum from direct contact with the POCL reagents and also prevents solvent evaporation during the imaging process. The thickness of the second top film should be significantly less than the areal dimensions of the imaging pixels on the rotating drum of the imaging device.

Any appropriate coating method known in the art may be employed to apply the POCL reagents to the electrophoresis gel, including: dip coating, rod coating, blade coating, air knife coating, gravure coating, reverse roll coating, extrusion coating, slide/cascade coating, or curtain coating (E. D. Cohen and E. B. Gutoff, eds. (1992) Modern Coating and Drying Technology, Wiley-VCH, New York, incorporated herein by reference).

One such coating apparatus capable of continuously producing such a sandwich structure includes two opposed, counter-rotating precision rollers oriented horizontally, one conveying the electrophoresis gel and the other conveying the second top film to the narrow; precision slot formed between the rollers. A bead of the POCL reagents is continuously applied across the width of the slot between the films on the rollers, thereby entraining the POCL reagents between the electrophoresis gel and the second top film.

Further, in embodiments in which there is more than one coating apparatus, each coating apparatus is configured independently of the other coating apparatuses. For example, the first coating apparatus includes a reservoir and a corresponding die, slot, or application roller for the first POCL reagent, and the second coating apparatus includes a reservoir and a corresponding die, slot, or application roller for the second POCL reagent. In certain embodiments, each coating apparatus has a different configuration from the other coating apparatuses, for example a combination of slot and blade coating apparatuses. In alternative embodiments, the coating apparatuses have the same configuration.

Spray coating methods using suitably configured nozzles may also be employed to apply POCL reagents either as a single, immediately premixed formulation, or as separately applied components.

Laminating apparatus 107 further includes a feeder unit with a roll support frame for supporting a continuous roll of the second top film. The feeder unit roll support frame includes at least two columnar frames and a rotary shaft positioned perpendicular to and attached to the columnar frames, such that the feeder unit roll support frame supports at least one roll of the second top film, in which each of the second top film rolls has a hollow tube along a central axis in a generally horizontal position such that the rolls of the second top film slide onto the rotary shaft.

The conveyance apparatus then conveys the electrophoresis gel to an imaging device 106. The imaging device includes a rotating drum, in which an exterior surface of the drum includes a plurality of color sensitive pixels. The width of the rotating drum is equal to or greater than the width of the electrophoresis gel. In certain embodiments, the surface of the rotating drum contains for example, at least about a billion pixels, or at least about a trillion pixels, with the pixels being capable of collecting data in parallel.

The imaging device 106 is configured such that the second top film of the electrophoresis gel is in contact with the color sensitive pixels of the imaging device 106 as the electrophoresis gel is being conveyed along the conveying path. A cylindrical pixel array could either be fashioned directly on the surface of the rotating drum, using a combination of coating and lithography methods, or applied to the surface of the drum as a flexible sheet of pixels. Each pixel of the imaging device 106 includes at least one photodiode and at least one thin film transistor, and the pixels are connected by at least one electrode to underlying readout circuitry. Semiconducting polymers are exemplary materials from which to fashion such a detector array, both for the photodiodes and the underlying readout circuitry. Amorphous silicon photodiodes and thin film transistors can also be used to create such a pixel-covered drum, or used in combination with semiconducting polymers.

Contact sensors, for example, large-area direct contact sensors, have been fabricated using amorphous silicon (Kakinuma, H. et al. (1991) IEEE Electron Device Letters 12:413-415). Page-size amorphous silicon image sensor arrays for high-speed color copiers and methods of making these arrays are shown in Lemmi, F. et al. (2001) Appl. Phys. Lett. 76(10):1334-1336; Knipp, D. et al. (2006 Sensors and Actuators A 128:333-338; Steibig, H. et al. (2006) Appl. Phys. Lett. 88:013509; and Stiebig, et al. (U.S. Pat. No. 5,998,806). The monochromatic nature of simple, silicon-based photodiode sensors has been overcome in these designs by more complex pixel structures in which photons of different wavelengths are absorbed and detected at different depths in the silicon structure.

The polymer photodiode structure can be used either as a light emitting diode (LED) or as a photosensor, depending on the details of its fabrication and operation, as shown in Heeger, et al. (U.S. Pat. No. 5,504,323). Such sensors have high-sensitivity and can be combined with color filters to create linear scanning sensors (Yu, G. et al. (1999) Synthetic Metals 102:904-907; and Wang, J. et al. (2000) Organic Electronics 1:33-40; Yu, G. et al. (2000) Synthetic Metals 111-112:133-137). Readout circuitry that can be combined with semiconducting polymer arrays is shown in Yu et al. (U.S. Pat. No. 6,441,395). These polymer sensor arrays can be flexible or fashioned on curved substrates. Two-dimensional arrays with full-color, single-pixel detection are shown in Yu (U.S. Pat. No. 6,300,612) and Yu et al. (U.S. Pat. No. 6,483,099).

A 1 mm×1 mm single-pixel color sensor fabricated from semiconducting polymers directly on the surface of a poly(dimethylsiloxane) (PDMS) microfluidic chip for the detection of POCL using the components of Cyalume® blue, green and red light-sticks with 4-dimethylaminopyridine added as a catalyst is shown in Wang et al. ((2007) Lab on a Chip 7:58-63).

Since the imaging device 106 is configured such that the second top film of the electrophoresis gel is in contact with the color sensitive pixels of the rotating drum, the imaging systems and devices herein avoid additional steps of film processing and digital scanning, as is associated with conventional film-based bioluminescence and chemiluminescence imaging techniques (Roda, A. et al. (2004) Analytica Chimica Acta 541:25-35). In contrast, the imaging systems and devices herein directly capture and digitize the chemiluminescent emission over an area in contact with the sensor, eliminating the need for imaging optics or focusing system, and costs and complexities associated with these systems.

Each pixel of the imaging device is capable of detecting the colors within the visible and infrared light spectrum. For example, each pixel can detect each of the colors used to label the sequencing reactions, whether four colors, eight colors, sixteen colors, or greater in number.

The imaging systems and devices herein can be connected to at least one computer. The computer includes software that commands and controls the continuous imaging system and imaging device. For example, the computer includes software such that the computer operates as a programmable logic controller (PLC) that electronically controls interactions of the conveyance apparatus, coating and/or printing apparatuses, laminating apparatus, fixing reservoir, and imaging device with the electrophoresis gel being conveyed along the conveying path. A PLC and PLC software are commercially available from Rockwell Automation Allen-Bradley & Rockwell Software Brands (Milwaukee, Wis.).

In certain embodiments, the image processing can be carried out by special purpose logic readout circuitry, i.e., hardware that is part of the imaging system, rather than in software in the computer. In this configuration, the pixel data is processed directly in circuitry to avoid the storage requirements for capturing image data and the computational burden of post-processing such images. Edge detection circuitry defines the lanes on the electrophoresis gel and allows binning of the pixels across the width of the lane. Dye mobility shifts are applied, followed by base calling and quality metric calculation. The output from the imaging drum is thus a parallel stream of sequence reads with associated quality metrics, which could be piped directly and continuously into a genome assembly system.

Alternatively, the computer further includes software for processing the image data. An exemplary base calling program is shown in Ewing, B. and P. Green (1998) Genome Research 8:186-194; Ewing, B. et al. (1998) Genome Research 8:175-185. The continuous imaging system can be configured such that operating software and data processing software are installed on a single computer. Alternatively, the continuous imaging system can be configured such that the operating software is installed on one computer and the data processing software is installed on a different computer.

In certain embodiments, the imaging systems and devices herein can be connected to a continuous film electrophoresis system (taught in copending U.S. patent application Ser. No. ______, entitled, “Continuous film electrophoresis”, filed ______, incorporated herein by reference). A continuous electrophoresis system of the invention comprises a feeder unit with a roll support frame for supporting a continuous roll of a base film. The term “base film” as used herein refers to any suitable flexible support material for gel electrophoresis that can be spooled onto a roll or drum or similar configuration. Exemplary compositions that compose the base film include polymers and elastomers. Suitable polymer base films include continuous rolls of Mylar® (poly(ethylene terephthalate) or PET) film, commercially available from DuPont-Teijin Films (Hopewell, Va.). Advantages of PET film include low cost (approximately $0.01 to $0.02/ft²), ultra-thin, optically transparent, thermally stable, non-conductive and disposable. Other PET films suitable as a base for gel bonding include GelBond-PAG from Lonza (Basel, Switzerland). In certain embodiments, the base film is chemically modified to allow for covalent attachment of a polyacrylamide gel, which process is shown in Nochumson et al., U.S. Pat. No. 4,415,428, incorporated by reference herein.

In certain embodiments, the base film is disposable. In alternative embodiments, the base film is reusable, allowing for the use of a continuous belt, which further reduces costs. Suitable continuous belts include reinforced silicone elastomeric varieties such as those available from Specialty Silicone Fabricators, Inc. (Paso Robles, Calif.). In embodiments in which the base film is reusable, after imaging an electropherogram, the base film may be passed through one or more cleaning baths to remove the coated polymers. Such cleaning baths may include ultrasonic cleaning steps. Additionally, the belt may be exposed to an oxygen plasma to remove the remaining residue of the electrophoresis gel material from the base film and reactivate the base film for the next cycle of polymer matrix coating. Such in-line plasma cleaning devices are already widely utilized in industry and are commercially available from PVA TEPLA AMERICA (Corona, Calif.). Alternatively, the coated polymer matrix layer applied to a polymer or elastomer base film is “stripped” (i.e., physically and continuously delaminated) from the base film after imaging and prior to additional cleaning steps as outlined previously.

A system of the invention may further comprise a conveyance apparatus, as described above. The conveyance apparatus conveys the base film along a conveying path such that the base film interacts with other components of the continuous electrophoresis system. In certain embodiments, the conveyance apparatus is connectable to the feeder unit. In alternative embodiments, the conveyance apparatus is detached from the feeder unit.

Systems of the invention further comprise one or more coaters for depositing polymers, microcapsules and other reagents on the base film. In a particularly preferred embodiment, a system includes a slide or cascade coating apparatus capable of simultaneously applying multiple, precision thickness aqueous coatings and operably connected to the conveyance apparatus (Gutoff, E. B., “Premetered Coating” IN: Cohen, E. and E. Gutoff (Eds.) “Modern Coating and Drying Technology”, Wiley-VCH, New York, 1992, Chapt. 4, incorporated by reference herein). The coating apparatus may deposit the coated layers as a curtain or a bead to the base film. Alternatively, a slot coating apparatus may be employed to apply the necessary polymer layers to the base film. Each coating apparatus includes at least one reservoir connected to at least one die or slot. For example, the coating apparatus includes a plurality of reservoirs and a plurality of dies or slots.

The coating apparatus applies at least a coating of a sieving polymer matrix to the base film being conveyed along the conveying path to form an electrophoresis gel. An exemplary polymer matrix includes polyacrylamide, which is commercially available (Sigma-Aldrich, St. Louis, Mo.) and has been used for single-stranded DNA separations for DNA sequencing for at least 30 years (Sanger, F., S. Nicklen and A. R. Coulson (1977) Proc. Natl. Acad. Sci. USA 74(12):5463-5467; Maxam, A. and W. Gilbert (1977) Proc. Natl. Acad. Sci. USA 74(2):560-564 incorporated by reference herein). Another polymer matrix for single-stranded DNA separations in DNA sequencing includes agarose (U.S. Pat. No. 5,455,344 incorporated by reference herein). Methods and processes for applying a polymer matrix are described in U.S. patents by Ogawa et al. (U.S. Pat. Nos. 4,548,869; 4,548,870; 4,579,783; 4,582,868; 4,600,641; 4,657,656; 4,699,705; 4,718,998; 4,722,777; 4,737,258; 4,737,259; 4,806,434; 4,891,119; and 4,963,243) a U.S. patent by Sugihara et al. (U.S. Pat. No. 4,695,354), and a U.S. patent by Sugimoto et al. (U.S. Pat. No. 4,897,306), each of which is incorporated by reference herein. Preferred polymer systems for DNA sequencing are taught in Fredlake et al. (2008) Proc. Natl. Acad. Sci. USA 105(2):476-481.

Preferred coating technologies allow, for example, for simultaneous application of as many as 20 layers of polymer matrix in a single pass of the coating apparatus. The coating methods provide high precision tolerances, i.e., ±2%, cross web and down web on widths of up to 5 meters, and coating thicknesses of individual layers from about 50 nm to about 25 μm. Such coating apparatuses are capable of controlling fluids from about 1 cps to about 400 cps or higher and can achieve coating speeds as high as 2.5 km/min. Exemplary coating technology is available from TSE Troller (Murgenthal, Switzerland) and other similar vendors.

In certain embodiments, the coating apparatus applies a substantially uniform density of the sieving polymer matrix to the base film. In other embodiments, the coating apparatus applies a gradient of density of the sieving polymer matrix across the width of the base film. An advantage of a gradient gel is that it provides a mechanism for packing more bases into a given separation length by making the spacing between bands more uniform across a length of a gel. Methods of manufacturing gradient gels are shown in U.S. patents by Terai et al. (U.S. Pat. Nos. 4,966,792 and 4,968,535), each of which is incorporated by reference herein, and Sambrook et al. (Molecular Cloning—A Laboratory Manual, Cold Spring Harbor Laboratory Press, Cold Spring Harbor, N.Y., vol. 2, pp. 13-47, 1989).

In certain embodiments, to facilitate grafting or bonding of the sieving polymer matrix to the base film, the continuous electrophoresis system includes an ultraviolet (UV) irradiation device. This device is connected to conveyance apparatus and located after the sieving matrix coating apparatus. Methods of grafting or bonding of a sieving polymer matrix to the base film are shown in Uyama et al. (Journal of Applied Polymer Science, 36(5):1087-1096, 2003) and Uchida et al. (Journal of Polymer Science Part A: Polymer Chemistry, 27(2):527-537, 2003).

In an alternative embodiment, the coating apparatus comprises a plurality of printing apparatuses that apply a spatially-defined coating of the sieving polymer matrix to the base film such that physically separated sequencing lanes are defined on the base film. The printing apparatus generates sequencing lanes that are about 50 μm to about 10 μm or about 1 μm in width, and further generates the sequencing lanes such that the lanes are separated by hydrophobic regions, i.e., lanes of unmodified PET of similar dimensions as an example.

A second printing apparatus deposits an individual microcapsule containing Sanger extension products from a completed Sanger reaction to one end of each sequencing lane of the electrophoresis gel being conveyed along the conveying path. Because the microcapsules will be monodisperse, it is possible to eject the microcapsules from a suitable orifice single-file into the sieving polymer matrix layer. Multiple, parallel lines of microcapsules may similarly be injected into the first polymer matrix, spaced across the coated width of the base support film such that the spacing between parallel lines of microcapsules is greater than or equal to the separation length needed to fully-resolve the sequencing ladder. For example, currently available coating technology is able to apply uniform coatings across a 4.6 meter wide web. If the separation length needed to fully resolve a sequencing ladder is, e.g., 0.15 meters, then as many as 30 parallel tracks of sequence data may be produced across the width of the support film in a single coating operation.

Formation of microcapsules for conducting Sanger reactions is taught in co-pending U.S. patent application Ser. No. ______, entitled “Microcapsules and methods of use for amplification and sequencing”, and filed on ______, incorporated by reference here. Generally, microcapsules comprise a semipermeable membrane containing one or more enzymes and a nucleic acid template. The enzymes and nucleic acid template are located within an aqueous core of the microcapsule. The semipermeable membrane of the microcapsule allows for the free exchange of low molecular weight molecules (e.g., dNTPs, fluorescently labeled ddNTPs, short primers) and reaction byproducts (e.g., pyrophosphate). The semipermeable membrane, however, prevents enzymes and nucleic acid template from exiting the aqueous core of the microcapsule. Microcapsules are useful for enzyme-mediated reactions such as a polymerase-mediated reaction. For instance, a thermostable microcapsule comprises a semipermeable membrane, an aqueous core, one or more polymerases in the aqueous core, and a nucleic acid template in the aqueous core. Microcapsules may be any appropriate shape or size, but a preferred microcapsule is spherical and approximately 1-10 μm in diameter.

Microcapsules are thermostable and capable of withstanding thermocycling for PCR. By “thermostable”, it is meant that the microcapsule can withstand high temperatures such as those required to denature nucleic acids. Microcapsules are capable of withstanding high-speed flow sorting, for instance, sorting at greater than about 70,000/second. A collection of microcapsules is preferably of relative uniform size, i.e., are monodisperse, and have a diameter with a coefficient of variation of less than or about 10%.

Ideally, the semipermeable membrane of the microcapsule is impermeable to high molecular weight molecules. On the other hand, the semipermeable membrane is permeable to low molecular weight molecules such as low molecular weight reagents. For instance, the semipermeable membrane can be permeable to molecules possessing a molecular weight of less than or about 20,000 g/mol, less than or about 10,000 g/mol, less than or about 5,000 g/mol, or less than or about 3,000 g/mol. Alternatively, the semipermeable membrane is impermeable to enzymes and nucleic acids that are longer than about 70 nucleotides in length. For instance, the semipermeable membrane is impermeable to the nucleic acid template contained within the aqueous core of the microcapsule.

The semipermeable membrane of the microcapsule is permeable to small molecular weight reagents and reaction byproducts. Thus, in sequencing, the semipermeable membrane is permeable to deoxynucleotide triphosphates (dNTPs), dideoxynucleotide triphosphates (ddNTPs), labeled ddNTPs, labels and dyes, pyrophosphates, divalent cations (e.g., magnesium ions and manganese ions), monovalent cations (e.g., potassium ions), and nucleic acids that are shorter than about 70 nucleotides in length.

The semipermeable membrane can comprise any polymer known in the art that is permeable to low molecular weight reagents and impermeable to high molecular weight reagents. It is important that the polymer not prevent an enzymatic reaction from occurring in the aqueous core of the microcapsule. Polymers that can be used, include, but are not limited to, acrylic polymers including, but not limited to crosslinked polyacrylamide, cyanoacrylate, diacrylates including poly(ethylene glycol) diacrylate (PEG-DA) and poly(ethylene glycol) dimethylacrylate (PEG-DMA) of various chain lengths. The semipermeable membrane can also comprise, for instance, epoxy resins including DuPont's “Somos 6100” series of resins. Porogens, such as various chain length poly(ethylene glycol)s can also be included to adjust the molecular weight cut off (MWCO) of the polymer shell of the microcapsules.

The semipermeable membrane can comprise a polymer that is capable of cross-linking to control the stability and MWCO of the microcapsule. In one embodiment of the invention, the polymer is a photocrosslinkable polymer.

The nucleic acid template within the aqueous core of each microcapsule serves as a substrate for the enzyme-mediated reaction. In one embodiment, there is a single nucleic acid template, i.e., one molecule, in each microcapsule. For instance, the microcapsule comprises a semipermeable membrane, an aqueous core, one or more polymerase enzymes in the aqueous core, and one nucleic acid template in the aqueous core. In another embodiment, the microcapsule contains multiple copies of a single nucleic acid template.

The nucleic acid template can be either a DNA template or an RNA template, including genomic DNA, cDNA, mRNA, rRNA, tRNA, gRNA, siRNA, micro RNA, and others known in the art.

Although the nucleic acid template may be derived from a clone, it is unnecessary to clone the nucleic acid molecule in vivo prior to use in the microcapsule of the present invention. For instance, sheared or enzymatically digested genomic nucleic acids may be used as nucleic acid templates.

The nucleic acid template can vary in length so long as it is of sufficient size to prevent it from crossing the semipermeable membrane. For instance, the nucleic acid template can be about or greater than 100 nucleotides in length, about or greater than 200 nucleotides in length, about or greater than 300 nucleotides in length, about or greater than 400 nucleotides in length, about or greater than 500 nucleotides in length, about or greater than 600 nucleotides in length, about or greater than 700 nucleotides in length, about or greater than 800 nucleotides in length, about or greater than 900 nucleotides in length, about or greater than 1000 nucleotides in length, about or greater than 1100 nucleotides in length, or about or greater than 1200 nucleotides in length. The invention includes microcapsules comprising a nucleic acid template that is at least about 100 nucleotides in length, at least about 200 nucleotides in length, at least about 300 nucleotides in length, at least about 400 nucleotides in length, at least about 500 nucleotides in length, at least about 600 nucleotides in length, at least about 700 nucleotides in length, at least about 800 nucleotides in length, at least about 900 nucleotides in length, at least about 1000 nucleotides in length, at least about 2000 nucleotides in length, at least about 3000 nucleotides in length, at least about 4000 nucleotides in length, or at least about 5000 nucleotides in length.

The nucleic acid template may be either linear or circular, the circular topology having the added benefit of a reduced tendency to penetrate the polymer shell of the microcapsule.

The nucleic acid template should also contain at least one priming site for hybridization of a complementary primer oligonucleotide for DNA amplification.

The nucleic acid template may be single-stranded or double-stranded although the preferred template is single-stranded.

Microcapsules comprise one or more enzymes in the aqueous core. Examples of enzymes include nucleic acid modifying enzymes such as polymerases, reverse transcriptases, ligases, topoisomerases, Klenow fragment and restriction endonucleases. Examples also include thermophilic DNA polymerases, such as Taq polymerase DNA polymerase I, DNA polymerase II, DNA polymerase III holoenzyme, DNA polymerase IV, terminal transferase, Klenow fragment, T4 DNA polymerase, T7 DNA polymerase, BST DNA polymerase, and phi29 DNA polymerase. Additional examples of enzymes include various forms of “hot start” polymerases that are inactive at low temperatures (e.g., 40° C.) and only become active upon heating to relatively high temperatures (e.g., >90° C.).

In another embodiment, the enzymes are selected from a group of RNA polymerases, including, but not limited to, RNA polymerase I, RNA polymerase II, RNA polymerase III, and T7 RNA polymerase.

Microcapsules are permeable to low molecular weight reagents and buffers. Microcapsules further comprise one or more low molecular weight reagents. For example, the aqueous core is a buffer solution. Microcapsules can be stored or incubated in a solution comprising low molecular weight reagents and/or a buffer solution. Examples of low molecular weight reagents are described throughout this application and include dNTPs, ddNTPs, labeled ddNTPs (e.g., fluorescently labeled ddNTPs), divalent cations, monovalent cations, stabilizers and nucleic acid primers.

In one embodiment, the primers are able to pass through the semipermeable membrane of the microcapsule. Such primers can be up to about 70 nucleotides in length. For instance, primers that are about 5 to 10 nucleotides in length, 10 to 15 nucleotides in length, 10 to 20 nucleotides in length, 10 to 30 nucleotides in length, 15 to 25 nucleotides in length, or 25 to 30 nucleotides in length can be used with the microcapsule of the invention as well as primers that are about 40 or fewer nucleotides in length, about 50 or fewer nucleotides in length, about 60 or fewer nucleotides in length, and about 70 or fewer nucleotides in length. In one embodiment of the invention, the primers are about 20 to 50 nucleotides in length.

In another embodiment, each microcapsule contains one or more primers that are unable to diffuse out of the aqueous core due to size. As can be appreciated by a skilled artisan, the size of the primers can vary depending on the polymer used as a semipermeable membrane. However, generally, primers greater than about 70 nucleotides are unable to cross the semipermeable membrane of the microcapsule.

The primers are substantially complementary or perfectly complementary to a region of the nucleic acid template. In one embodiment, the primer contains a small number of mismatches compared to the nucleic acid template that do not interfere with the ability of the primer to anneal to the nucleic acid template under stringent conditions. Such a primer may contain 5 or fewer, 4 or fewer, 3 or fewer, 2 or fewer, or 1 mismatches compared to the nucleic acid template.

Universal primers can be used to hybridize with a common motif in the template. For example, the primer can be a poly-T primer that is capable of binding to a poly-A region in a template nucleic acid. Random primers are, of course, also useful.

The amplification reaction can be a PCR reaction (including rtPCR and others as described below) or can be another type of amplification, such as rolling circle amplification (RCA). Rolling circle amplification is described in U.S. Pat. Nos. 6,576,448; 6,977,153; and 6,287,824, each of which is incorporated by reference herein.

Microcapsules of the invention can be made by methods known in the art for forming membrane enclosed microcapsules, including, but not limited to, methods currently used for the microencapsulation of drugs and the like.

In one embodiment of the invention, microcapsules are formed using a multiple sheath flow device as disclosed in co-pending U.S. patent application Ser. No. ______, entitled “Methods of using a multiple sheath flow device for the production of microcapsules”, and filed on ______, incorporated by reference herein, which discloses a multiple sheath flow device. The device can be machined from PEEK and have three Upchurch (Oak Harbor, Wash.) inert capillary tubing inlet connections that carry: (a) an innermost liquid flow containing diluted nucleic acid templates and one or more enzymes to be incorporated into the microcapsules, (b) a coaxial flow of immiscible, semipermeable membrane forming material surrounding the inner core, and (c) an outer coaxial flow of a third solution or gas used to entrain microcapsules. The three coaxial fluids emerge through an aperture, for instance, through a precision sapphire aperture, as a liquid jet. The relative flow rates of the three fluid feeds can be adjusted to control the diameter of the microcapsules formed. The device can be operated at high pressure, using computer-controlled syringe pumps, to increase the rate of microcapsule formation and to minimize reagent consumption. The design of such a device can be modified to incorporate multiple apertures to further increase microcapsule output.

As can be appreciated by a skilled artisan, various nucleic acid amplification methods known in the art that employ an enzyme-mediated reaction can be easily modified for use with the present invention. The only requirement is that the one or more enzymes, nucleic acid template to be amplified, and, optionally, primers, be encapsulated within the semipermeable membrane of the microcapsule. For instance, in addition to polymerase chain reaction (PCR), other known amplifications methods such as rolling circle amplification (RCA), ligase chain reaction (European application EP 320 308), gap filling ligase chain reaction (U.S. Pat. No. 5,427,930), strand displacement amplification (U.S. Pat. No. 5,744,311) and repair chain reaction amplification (WO 90/01069) may be performed using the microcapsules as disclosed herein.

In one embodiment, microcapsules are used to amplify a nucleic acid template by polymerase chain reaction. In this case, the microcapsule contains a thermostable DNA polymerase (e.g., Taq polymerase) and a nucleic acid template for amplification. Preferably, the aqueous core and liquid surrounding the microcapsule contain a PCR buffer solution and dNTPs. Primers that are complementary to the nucleic acid template may be located within the aqueous core or, if capable of traversing the semipermeable membrane, in the PCR buffer solution bathing the microcapsule.

To perform PCR, one to over a billion microcapsules are placed in a tube with the appropriate PCR reagents. As with traditional PCR, the tube is placed in a thermocycler under conditions necessary for PCR (i.e., cycles of denaturation, annealing, and elongation). Briefly, in a thermocycler, the microcapsules are denatured by heating (e.g., 94° C. to 98° C.) for about 20 to 30 seconds. The microcapsules are then subjected to an annealing temperature (e.g., about 50° C. to 65° C.) for about 20 to 40 seconds. Elongation proceeds next. The elongation temperature (usually about 72° C. to 80° C.) and time (about 1,000 bases/minute) required for the elongation step depend on the polymerase enzyme used and length of nucleic acid template, respectively. The denaturation, annealing, and elongation steps are repeated several times (usually about 20 to 30 cycles) and may be capped off with an extended elongation step.

One or multiple nucleic acid templates may be amplified in a single reaction using one or a plurality of microcapsules. In one embodiment of the invention, each microcapsule contains multiple nucleic acid templates that are amplified by PCR (i.e., multiplex PCR). In a preferred embodiment of the invention, each microcapsule contains a single nucleic acid template that is amplified by PCR. In another preferred embodiment, billions of microcapsules, each microcapsule containing a single nucleic acid template, are amplified by PCR.

In a preferred embodiment, microcapsules are used to amplify a nucleic acid template by rolling circle amplification (RCA). In this case, the microcapsule contains a strand displacement DNA polymerase (e.g., phi29 polymerase) and a circular nucleic acid template for amplification. Preferably, the aqueous core and liquid surrounding the microcapsule contain a RCA buffer solution and dNTPs. A primer that is complementary to the circular nucleic acid template may be located within the aqueous core or, if capable of traversing the semipermeable membrane, in the RCA buffer solution bathing the microcapsule.

To perform RCA, one to over a billion microcapsules are placed in a tube with the appropriate RCA reagents. Isothermal amplification (e.g., 40° C.) of the circular template results in a linear concatamer of very high molecular weight that does not cross the polymer membrane of the capsule. Microcapsules can also be used in reverse transcriptase amplification reactions. In this embodiment of the invention, each microcapsule comprises a semipermeable membrane, an aqueous core, a reverse transcriptase and an RNA template for amplification.

In one embodiment of the invention, a starting nucleic acid template is amplified within a microcapsule as described above prior to sequencing. Although not necessary, one or more microcapsules that have previously been subjected to an amplification reaction can be “cleaned-up” prior to sequencing by dialyzing against a suitable buffer.

In one embodiment, microcapsules that have previously undergone amplification are used in a Sanger sequencing reaction. Depending on the number of templates to be sequenced, one to thousands, even millions or billions, of microcapsules are placed in a tube with sequencing reagents. Sequencing reagents include dNTPs, ddNTPs and primers. Preferably, the ddNTPs are fluorescently labeled so that all four ddNTPs can be incorporated into the growing DNA chain in a single reaction. Importantly, the fluorescent labels are chosen for their stability and quantum efficiency when used in combination with POCL excitation chemistry.

Depending on the desired read length of the sequencing reaction (e.g., 1,000 bases) and the sensitivity requirements of the fluorescence detection system (e.g., 1,000 labeled fragments per band), then the total number of Sanger extension products can be estimated (e.g., 1,000×1,000=1 million). If the initial single molecule template in each capsule has already been amplified to an equivalent number of copies (e.g., 1 million), then only a single cycle of polymerase extension and ddNTP termination will be required to produce the required number of Sanger extension products. If, however, the initial single molecule template in each microcapsule has been amplified to a lesser extent, then multiple cycles of polymerase extension and ddNTP termination can be employed using cycle sequencing to generate the necessary number of extension products. Cycle sequencing is performed in a thermocycler by methods known in the art.

Upon completion of the sequencing reaction, it is preferable that unincorporated ddNTPs, dNTPs primers and pyrophosphates are removed. In one embodiment of the invention, unwanted reagents and byproducts are removed by dialysis against a suitable buffer.

In one embodiment of the invention, it is preferred that each microcapsule contains a single starting nucleic acid template. Poisson statistics dictate the dilution requirements needed to insure that each microcapsule contains only a single starting nucleic acid template. For example, if, on average, each microcapsule is to contain only a single template, about ⅓ of the microcapsules will be empty and contain no nucleic acid template, about ⅓ will contain exactly one nucleic acid template, and about ⅓ will contain two or more templates.

The microcapsule population may be enriched to maximize the fraction that started with a single nucleic acid template. Because the Sanger sequencing reaction incorporates fluorescently labeled ddNTPs, it is possible to flow sort the microcapsules after sequencing (and, preferably, after a purification step) to enrich for those that are fluorescent rather than empty. High speed flow sorters, such as the MoFlo™ (Beckman-Coulter, Inc., Fullerton, Calif.), are capable of sorting at rates in excess of 70,000 per second and can be used to enrich a population of microcapsules of the invention. Similarly, it is possible to exploit other differences between empty and full microcapsules (e.g., buoyant density) to enrich a population of microcapsules. In order to enrich for microcapsules with one starting nucleic acid template as opposed to several different starting templates, it may be desirable to skew the Poisson distribution accordingly.

The coating apparatus as disclosed herein is able to apply all of the microcapsules, both empty and containing Sanger extension products from a completed Sanger reaction. Thus the empty microcapsules may serve as spacers between adjacent sequencing lanes in the electrophoresis gel. Poisson statistics are adjustable to yield the proper balance between wasting lanes in the electrophoresis gel with no sequencing products and overcrowding of the gel such that the resulting sequencing ladders overlap too frequently.

In an alternative embodiment, a coating apparatus applies an immiscible liquid or polymer film over the sequencing gel layers in lieu of the upper film lamination. Silicone heat transfer liquid (commercially available from Dow Coming, Midland, Mich.) is an example of such a coating material. The silicone liquid provides a lid for the sequencing channels, similar to the second glass plate in conventional slab gel electrophoresis, providing a non-conductive, insulating barrier for evaporative loss from the gel and removing the need for a solid film barrier.

The electrophoresis gel film containing the microcapsules in then conveyed along the conveying path to the buffer reservoir of the continuous electrophoresis system. The buffer reservoir includes at least one extended anode along one side of the reservoir adjacent to one edge of the film, and at least one extended cathode along the opposite side of the reservoir adjacent to the other edge of the film, wherein the buffer reservoir is configured such that the electrophoresis buffer is in fluid and therefore electrical contact with the outer exposed edges of the electrophoresis gel. Additionally, the buffer reservoir includes at least one anode connection, and at least one cathode connection. A high-voltage source is connected to the at least one anode connection, and the at least one cathode connection. Suitable high-voltage sources for gel electrophoresis are commercially available from American High Voltage (Elko, Nev.). The buffer reservoir is configured such that the electrophoresis buffer is in fluid, and therefore electrical, contact with the exposed edges of the electrophoresis gel, allowing electrophoretic separation of the Sanger extension products during the time that the sequencing gel film is immersed in the buffer reservoir as it is continuously transported through the sequencing system by the conveying means. The buffer reservoir includes the characteristics described above for the fixing reservoir.

Exemplary running buffers include, Tris-Borate-EDTA (TBE), Tris-Acetate-EDTA (TAE), or preferably 49 mM Tris, 49 mM N-(Tris(hydroxymethyl)methyl)3-aminopropanesulfonic acid, 2 mM EDTA (TTE). In other embodiments, the electrophoresis buffer is a low conductivity buffer, such as those commercially available from Lonza (Walkersville, Md.) or Faster Better Media, LLC (Hunt Valley, Md.). The low conductivity buffer reduces the Joule heating generated by the continuous electrophoresis system during electrophoretic separation of the Sanger extension products.

The electrophoresis is run until the Sanger extension products are fully resolved. For example, electrophoretic separation of the Sanger extension products within the electrophoresis gel film resolves hundreds of bases in a few minutes or less. Upon full resolution of the Sanger extension products in the electrophoresis gel film, the film emerges from the buffer reservoir and is conveyed along the conveying path to the imaging systems and devices of the invention herein.

Another aspect of the invention includes a method for imaging nucleic acids, the method includes: removing a first top film of an electrophoresis gel containing the nucleic acids, exposing a top surface of the electrophoresis gel, as the electrophoresis gel is being conveyed along a conveying path; fixing the nucleic acids and drying the electrophoresis gel; applying peroxyoxalate chemiluminescent chemistry reagents and a second top film to the exposed top surface of the electrophoresis gel; and imaging the nucleic acids. In certain embodiments, the method is accomplished using the imaging system described above.

Another aspect of the invention herein provides a device for continuous imaging of nucleic acids, the device including: a rotating drum, in which an exterior surface of the drum includes a plurality of slits and a plurality of color sensitive pixels, in which an interior of the drum includes at least one light source configured to emit light through the slits in the exterior surface of the drum.

In this configuration, the imaging device can be utilized to detect fluorescently labeled nucleic acids in the electrophoresis gel. The light emitted through the slits in the rotating drum of the imaging device results in excitation of fluorescent labels incorporated into the separated Sanger extension products in the electrophoresis gel, which excitation is detected by the color sensitive pixels on the exterior surface of the rotating drum of the imaging device. Exemplary light sources include a lamp (commercially available from Bio-Rad Laboratories, Inc., Hercules, Calif.), a laser (commercially available from Sintec Optronics, Japan), or a light emitting diode (LED; commercially available from Koninklijke Philips Electronics N.V., Netherlands).

Dye-labeled primers are shown in Smith et al. (Nature (1986) 321:674-679), and dye-labeled dideoxynucleotide terminators are shown in Prober et al. (Science (1987) 238:336-341). Fluorescent labels offer a number of significant advantages over isotopes. Each single fluorophore can potentially be excited to rapidly emit at least one million photons, providing a million-fold increase in the signal strength. In addition, four different dyes with non-overlapping emission spectra can be utilized to label the sequencing reactions, allowing all four bases to be read from a single lane on the gel.

In other related embodiments, the imaging device includes at least one light source, e.g., a lamp, a laser, or an LED, configured so as to excite the fluorescence of the labeled Sanger extension products within the sieving matrix layer, which serves as a waveguide. Thus, in this embodiment, fluorescence excitation from the edges of the rotating drum provides for total internal reflection fluorescence (TIRF) excitation.

Such light sources will launch their excitation light through prisms, gratings or other suitable coupling means contacting the outer edge(s) of the electrophoresis gel film on the rotating drum. In this embodiment, the sieving matrix layer of the electrophoresis gel has a higher refractive index than the refractive index of either of the polymer layers, e.g., EOF suppression layers, on either side of the sieving matrix layer of the electrophoresis gel sandwich. In this embodiment, the gel is imaged after emerging from the continuous electrophoresis process, eliminating the steps of removing the top film, gel fixing, gel drying, POCL coating, and top film re-lamination. Fluorescent emission from the bands excited within the sieving matrix layer waveguide is then detected by the color sensitive pixels covering the surface of the drum in contact, for example direct contact, with the gel film.

The invention having now been described, it is further illustrated by the following examples and claims, which are illustrative and are not meant to be further limiting. Those skilled in the art will recognize or be able to ascertain using no more than routine experimentation, numerous equivalents to the specific systems and processes described herein. Such equivalents are within the scope of the present invention and claims. The contents of all references, including issued patents and published patent applications cited throughout this application, are hereby incorporated by reference in their entirety.

### EXAMPLES

### Example 1

The following example demonstrates an embodiment of the manufacture and use of microcapsules according to the invention.

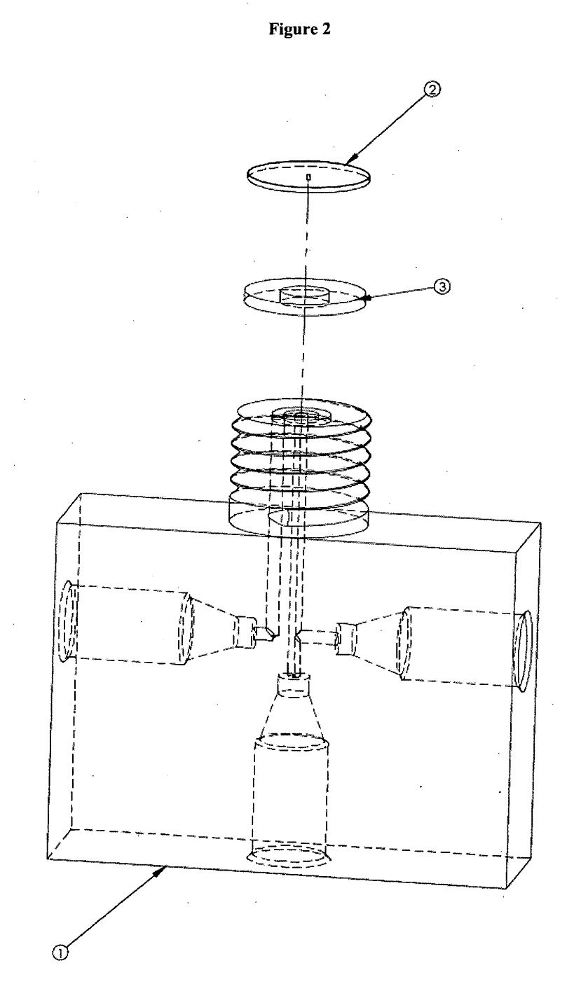

Three model NE500 syringe pumps (New Era Pump Systems, Inc., Wantagh, N.Y.) controlled by a PC running WinPumpControl software (Open Cage Software, Inc., Huntington, N.Y.) deliver fluids to the flow focusing nozzle inlet fittings illustrated in FIG. 2. An appropriately sized Luer-Lok® syringe is mounted on each pump and connected to the flow focusing nozzle by PEEK capillary tubing (Upchurch Scientific, Oak Harbor, Wash.). The pinhole aperture in the flow focusing nozzle is a model RB 22824 sapphire orifice (Bird Precision, Inc., Waltham, Mass.). The cylindrical portion of the orifice is 235 μm in diameter and 533 μm long. The innermost flow focusing tube delivering the Core Solution to be encapsulated is made of PEEK with an ID of 150 μm and an OD of 360 μm. This innermost tube is centered in a second PEEK capillary tube with an ID of 762 μm and an OD of 1587 μm, delivering the Polymer Shell Solution as a surrounding coaxial flow through the annular gap between the tubes. The exit end of the innermost tube is recessed by 500 μm from the exit tip of the surrounding tube, which is positioned at a height of 500 μm and centered on the orifice. The Focusing Solution is provided as a third coaxial flow through the annular gap between the machined body of the flow focusing nozzle and the outer capillary tube.

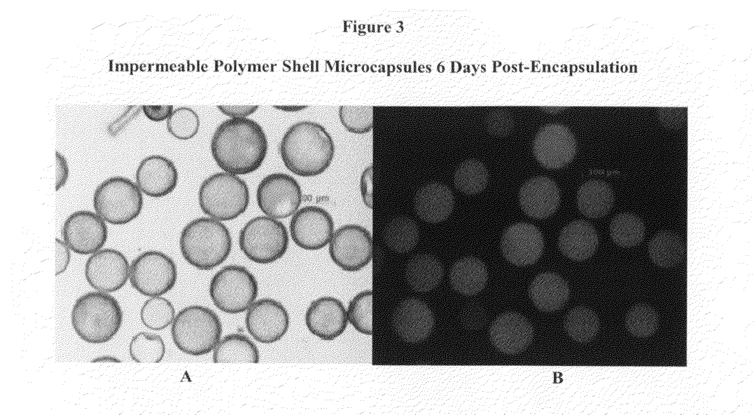

To form impermeable polymer shell microcapsules, the following three solutions were delivered to the flow focusing nozzle at the indicated volumetric flow rates: (1) Core Solution—sodium fluorescein (5 mg/mL—Fluka/Sigma-Aldrich, St. Louis, Mo.), glycerin (25% v/v—Walgreens, Deerfield, Ill.) in distilled water at 0.1 mL min⁻¹; (2) Polymer Shell Solution—PEGDMA 200 (polyethylene glycol 200 dimethacrylate) (Monomer-Polymer & Dajak Labs, Inc., Feasterville, Pa.), 4.76% v/v 2-hydroxy-2-methyl propiophenone (Sigma-Aldrich, St. Louis, Mo.), 0.4% v/v TEMED (N,N,N′,N′-tetramethylethylenediamine) and 0.05 g/mL 2,2-dimethoxy-2-phenyl-acetophenone (Sigma-Aldrich, St. Louis, Mo.) at 0.15 ml min⁻¹; and (3) Focusing Fluid—1% poly(vinyl alcohol) 87-89% hydrolyzed (Typical M_{w} 85,000-124,000) (Sigma-Aldrich, St. Louis, Mo.) in distilled water at 6.5 mL min⁻¹. The orifice of the flow focusing nozzle is positioned ˜15 cm above the liquid surface of a 100 mL beaker containing 50 mL of the Focusing Fluid to collect the microcapsules. The beaker sits on a near-UV transilluminator (Spectroline Slimline™ Series 365-8 W, Spectronics Corporation, Westbury, N.Y.) to provide 360 nm illumination for photoinitiation. In addition, two 40 W “black light” fluorescent lamps (GE F40BLB—General Electric Company, Fairfield, Conn.) are positioned ˜10 cm to the side of the emerging liquid jet to photoinitiate polymerization of the shell of the microcapsule prior to “splash down” in the collection beaker. Aliquots (35 μL) of microcapsules are mounted on a microscope slide and examined in an Axiovert 25 inverted microscope (Carl Zeiss MicroImaging, Inc., Thornwood, N.Y.). Digital images are captured using an AxioCam CCD camera (Carl Zeiss MicroImaging, Inc., Thornwood, N.Y.) and analyzed using AxioVision software Ver 4.6 (Carl Zeiss MicroImaging, Inc., Thornwood, N.Y.). Fluorescence imaging employs a 50 W Hg lamp illuminator (Carl Zeiss MicroImaging, Inc., Thornwood, N.Y.) and a FITC filter cube (484 nm excitation, 494/521 nm emission) (Carl Zeiss MicroImaging, Inc., Thornwood, N.Y.). Example bright field and fluorescence images of impermeable polymer shell microcapsules generated using the above described system are provided in FIGS. 3A and 3B. Encapsulation efficiency of the fluorescein labeled Core Solution is estimated at 99% with a mean microcapsule diameter of 90 μm±15 μm and a shell thickness of 5 μm. Microcapsule formation rate is estimated at ˜11,000 sec⁻¹. Microcapsules examined immediately after polymerization are indistinguishable from those placed in distilled water for up to several weeks at room temperature, indicating no loss of fluorescein. The polymer shells of these microcapsules are therefore impermeable to fluorescein (M_{R} 376).

### Example 2

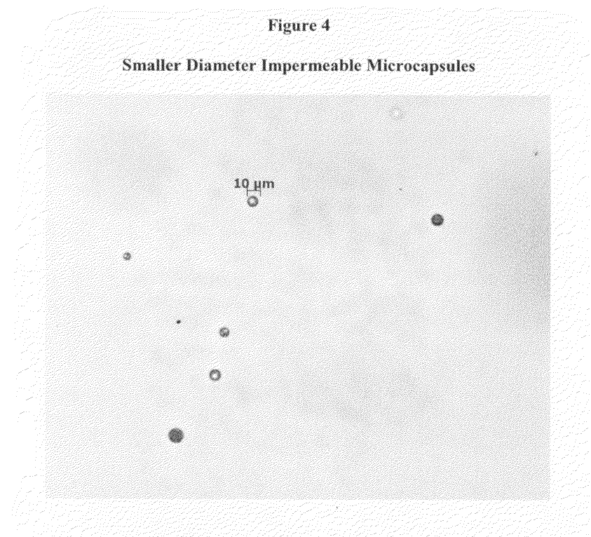

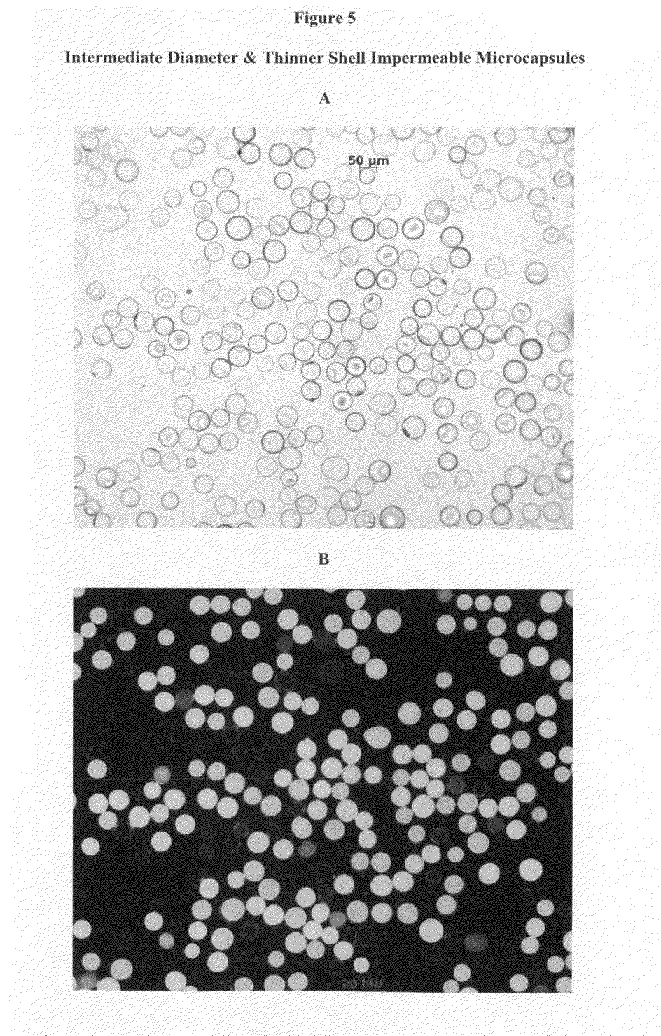

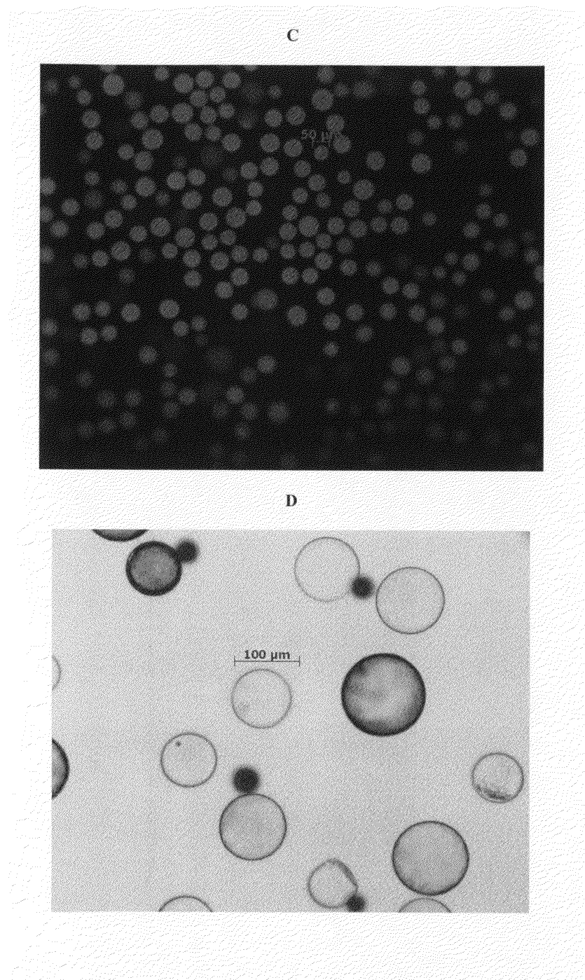

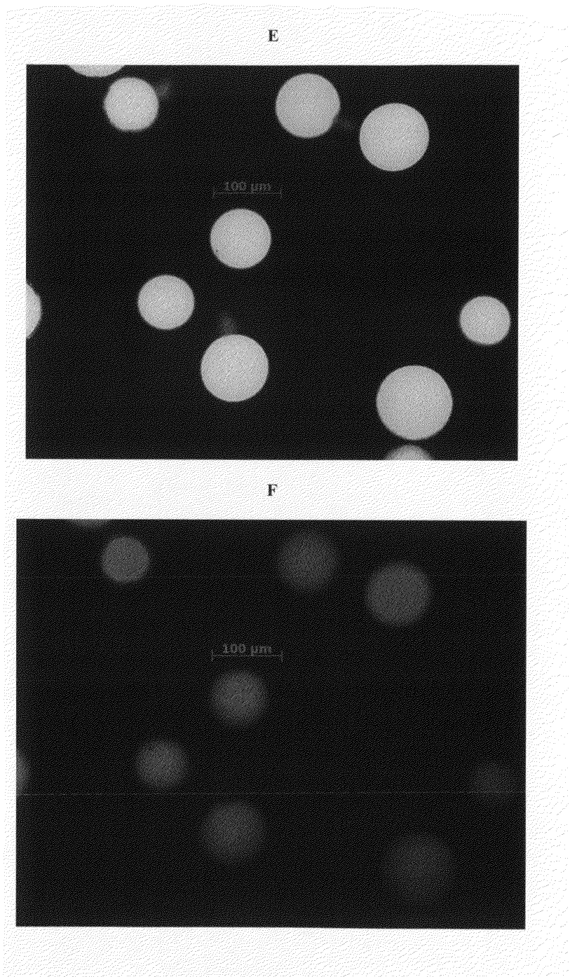

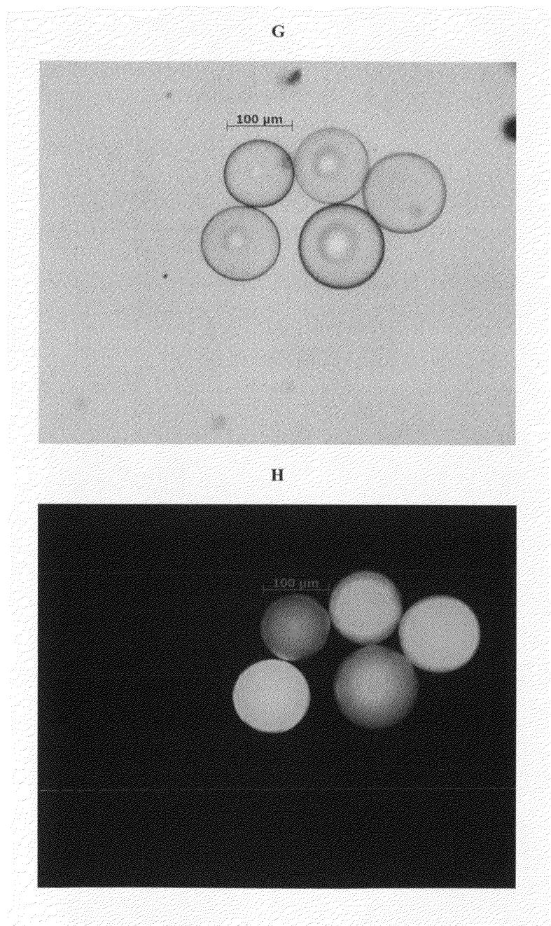

Smaller diameter impermeable polymer shell microcapsules are generated by adjusting the relative flow rates of the solutions from Example 1 as follows: Core Solution—0.025 ml min⁻¹; Polymer Shell Solution—0.05 ml min⁻¹; and Focusing Fluid—6.0 ml min⁻¹. The resulting microcapsules, illustrated in FIG. 4, are <10 μm in diameter.

### Example 3

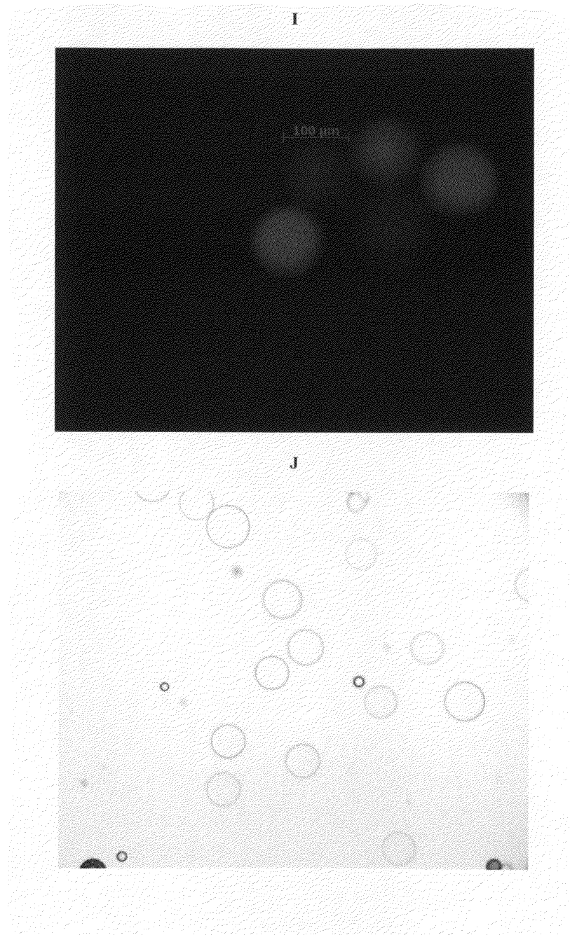

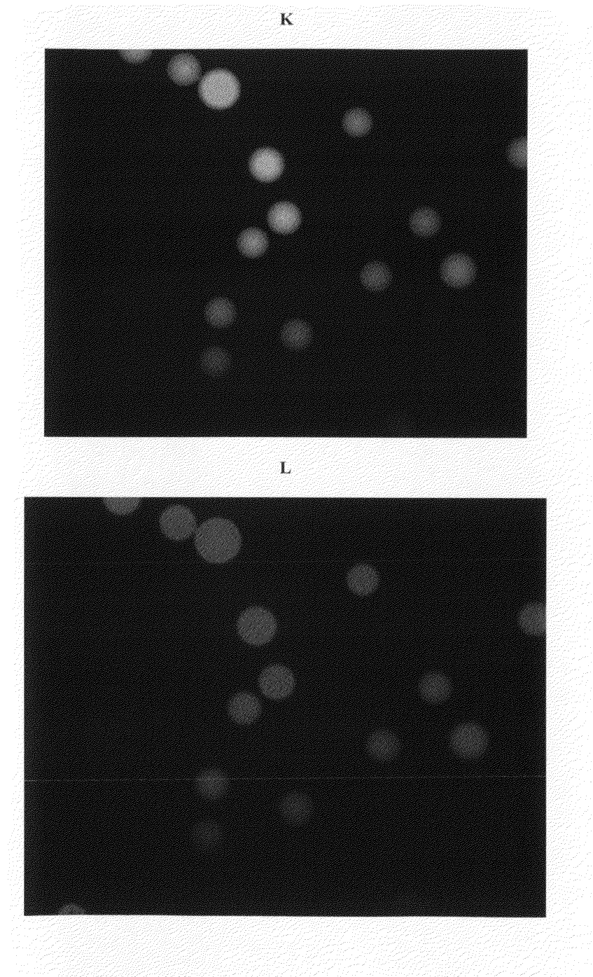

Intermediate diameter and/or thinner shell impermeable polymer microcapsules can also be produced using an alternative Polymer Shell Solution, blending PEGDMA 200 with PEGDA (poly(ethylene glycol) diacrylate of different chain lengths (PEGDA575-Mₙ˜575 or PEGDA700-Mₙ˜700—Sigma-Aldrich, St. Louis, Mo.) in the ratio of 4:1 PEGDMA 200:PEGDAXXX and by adjusting the relative flow rates of the three solutions The Core Solution is composed of a low molecular weight fluorescent marker (sodium fluorescein M_{w}=376 Da) and a high molecular weight marker (rhodamine B isothiocyanate-labeled dextran M_{w}=10 kDa) loaded together into the microcapsules in approximately equimolar amounts using the following composition: sodium fluorescein (0.26 mg/mL—Fluka/Sigma-Aldrich, St. Louis, Mo.) and rhodamine B isothiocyanate-dextran (5 mg/mL—Sigma-Aldrich, St. Louis, Mo.) and glycerol (25% v/v—Sigma, St. Louis, Mo.) in distilled water. Intermediate size microcapsules measuring ˜50 μm in diameter were produced using PEDGA575 with the following flow rates: Core Solution—0.05 ml min⁻¹, Polymer Shell Solution—0.010 ml min⁻¹, and Focusing Fluid—15 ml min⁻¹. The resulting microcapsules are shown in FIG. 5A-C. Progressively thinner polymer shells were produced using PEGDA700 by reducing the Polymer Shell Solution flow rate from 0.10 (FIGS. 5D-F) to 0.08 (FIGS. 5G-I) to 0.05 ml min⁻¹ (FIGS. 5J-L) while keeping the Core Solution and Focusing Fluid flow rates contant at 0.10 ml min⁻¹ and 6.5 ml min⁻¹ respectively.

### Example 4

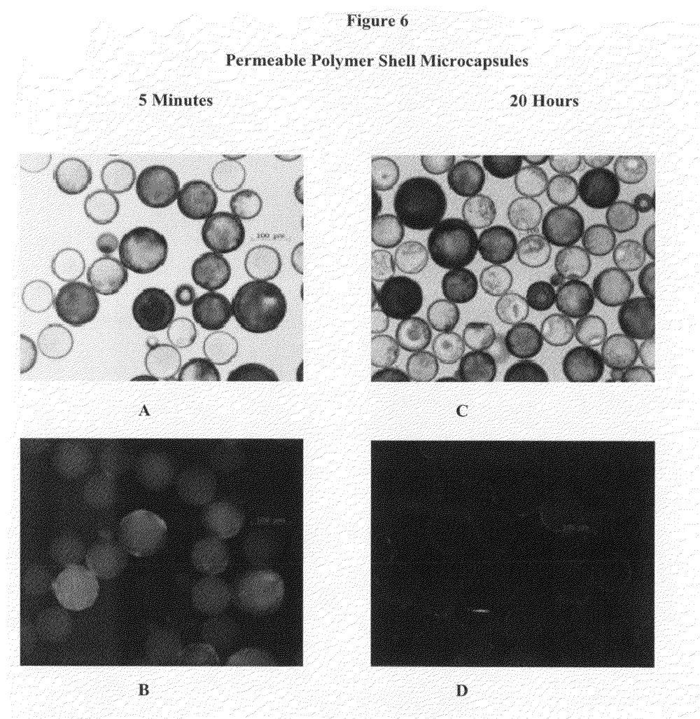

Permeable microcapsules are generated under identical conditions to Example 1 except for the addition of 5% v/v acrylic acid (Sigma-Aldrich, St. Louis, Mo.) to the Polymer Shell Solution as shown in FIGS. 6A-D. Encapsulation efficiency, microcapsule diameter and shell thickness are identical to the impermeable microcapsules, but display a darker and rougher appearance. Microcapsules imaged 5 minutes after formation display fluorescein content similar to that of the impermeable capsules, but when imaged after 20 hour incubation in distilled water at room temperature, the microcapsules have lost most of their fluorescein content while retaining their intact shell morphology, providing evidence of their permeability to fluorescein (M_{R} 376).

### Example 5

Semi-permeability of the polymer shell of the microcapsules as produced in Example 4 was demonstrated by comparing the relative loss/retention of a low molecular weight fluorescent marker (sodium fluorescein M_{w}=376 Da) and a high molecular weight marker (rhodamine B isothiocyanate-labeled dextran M_{w}=10 kDa) loaded together into the semi-permeable microcapsules in approximately equimolar amounts as described in Example 3. All conditions were identical to those in Example 4, except for the composition of the Core Solution, which was modified as follows: sodium fluorescein (0.26 mg/mL—Fluka/Sigma-Aldrich, St. Louis, Mo.) and rhodamine B isothiocyanate-dextran (5 mg/mL—Sigma-Aldrich, St. Louis, Mo.) and glycerol (25% v/v—Sigma, St. Louis, Mo.) in distilled water. Impermeable micorcapsules were prepared as controls using conditions identical to those provided in Example 1 with the Core Solution detailed above.

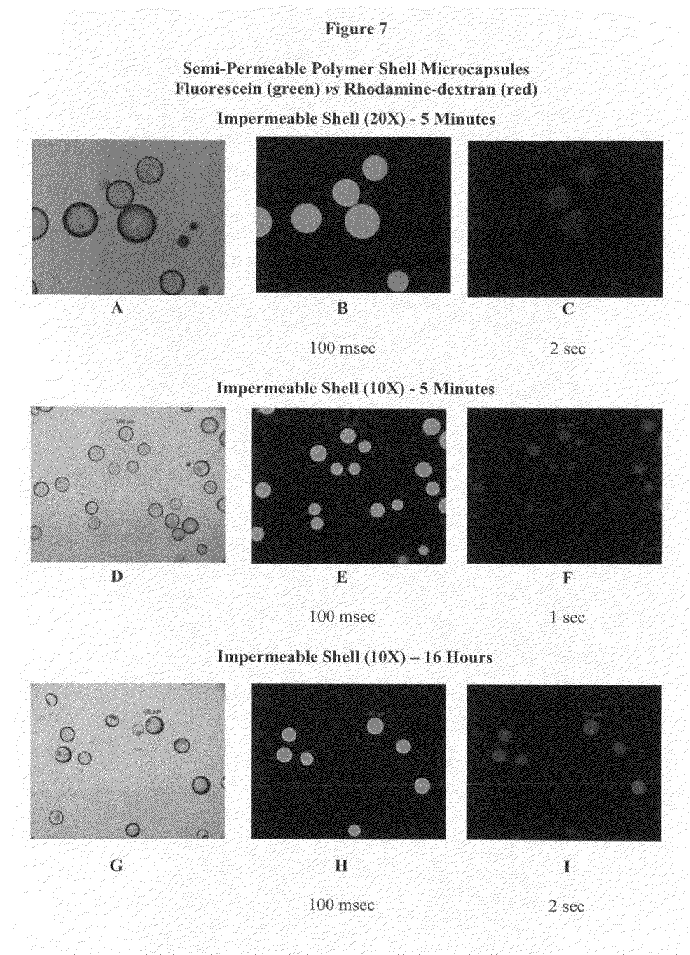

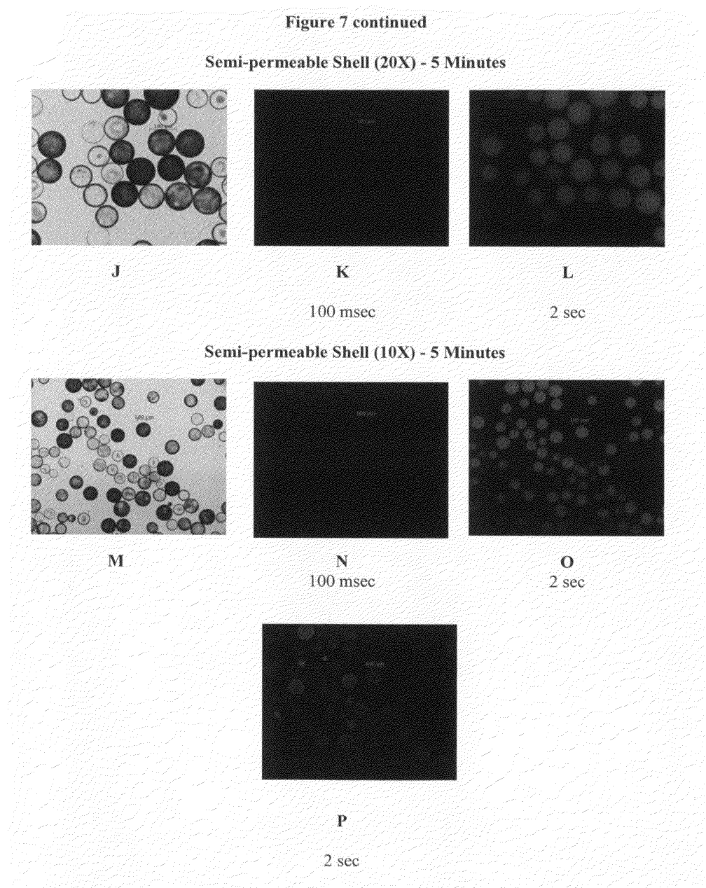

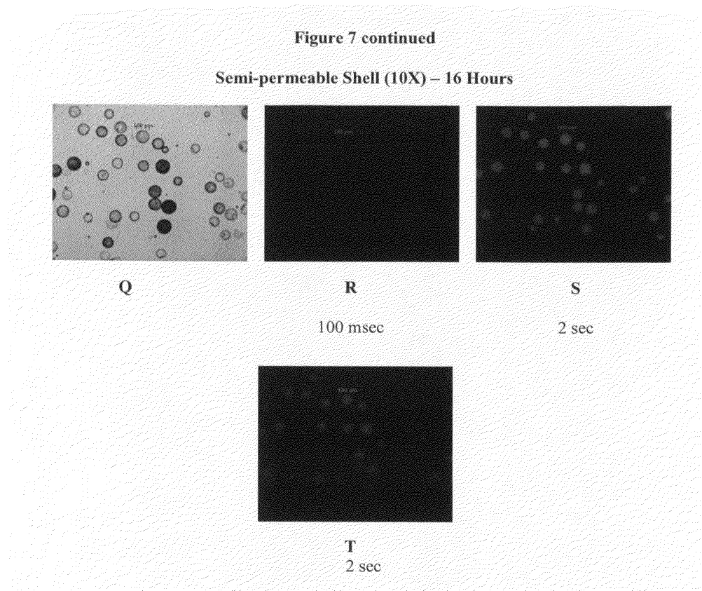

The harvested microcapsules were imaged directly in Focusing Fluid without washing ˜5 minutes after they were created. The microcapsules were then stored at room temperature in Focusing Fluid for ˜16 hours and reimaged. Brightfield and fluorescence images are provided in FIG. 7 below. Exposure times are indicated below each fluorescent image.

There was substantial loss of fluorescein within 5 minutes from the semi-permeable capsules compared with the impermeable control microcapsules, while there was no obvious loss of the rhodamine-labeled dextran even after 16 hours in the semi-permeable microcapsules, indicating that these microcapsules were preferentially permeable to the lower molecular weight fluorescein while retaining the higher molecular weight rhodamine-labeled dextran polymer. The Molecular Weight Cut Off (MWCO) of the semipermeable polymer shell membrane of these microcapsules is therefore >400 Daltons but <10,000 Daltons.

### Example 6

Altered permeability characteristics of polymer shell microcapsules were demonstrated as described in Example 2 using an alternative Polymer Shell formulation. All conditions were identical, except for the composition of the Core Solution, which was modified as follows: fluorescein isothiocyanate-dextran (2 mg/mL—Fluka/Sigma-Aldrich, St. Louis, Mo.) and rhodamine B isothiocyanate-dextran (5 mg/mL—Sigma-Aldrich, St. Louis, Mo.) and glycerol (25% v/v—Sigma, St. Louis, Mo.) in distilled water, and the Polymer Shell Solution, which was modified as follows: 2:1 v/v PEGDMA 200 and MPEOEA (methoxypoly(ethyleneoxy)ethyl acrylate) (Monomer-Polymer & Dajak Labs, Inc., Feasterville, Pa.).

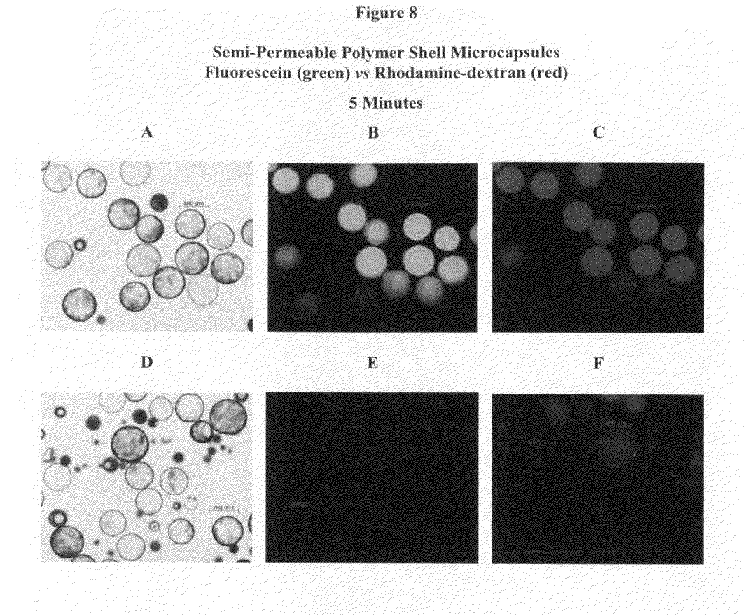

The harvested microcapsules were imaged directly in Focusing Fluid without washing ˜5 minutes after they were created. The microcapsules were then stored in the dark at room temperature in Focusing Fluid for ˜24 hours and reimaged. Brightfield and fluorescence images are provided in FIG. 8. Exposure times are indicated below each fluorescent image.

There was no significant loss of either fluorescent signal from the permeable capsules within 5 minutes compared with the impermeable control microcapsules. However, at t=24 hrs, both signals had decreased significantly with this polymer shell formulation. The Molecular Weight Cut Off (MWCO) of the permeable polymer shell membrane of these microcapsules is therefore >10,000 Daltons.

### Example 7

Semi-permeability of the polymer shells of the microcapsules was further demonstrated by encapsulation of high molecular weight DNA (single-stranded M13mp18 DNA—M_{w} 2.4 MDa, 7,249 bases) in the microcapsules and then labeling the DNA inside the microcapsules by incubating them in an exogenously added, low molecular weight fluorescent dye specific for single-stranded DNA (OliGreen®, M_{w}<1,000 Da—Invitrogen/Molecular Probes, Eugene, Oreg.). Semi-permeable microcapsules were produced as described in Example 5. All conditions were identical, except for the composition of the Core Solution, which was modified as follows: single-stranded M13mp18 DNA (20 μg/mL—Sigma-Aldrich, St. Louis, Mo.) in 1× TE buffer (10 mM Tris (TRIZMA®—tris(hydroxymethyl)aminomethane hydrochloride—Sigma-Aldrich, St. Louis, Mo.), 1 mM EDTA (ethylenediamenetetraacidic acid—Sigma-Aldrich, St. Louis, Mo.), pH 8.1) containing glycerol (25% v/v—Sigma-Aldrich, St. Louis, Mo.), and the Polymer Shell Solution, which was modified as follows: 10:1 v/v PEGDMA 200 and MPEOEA (methoxypoly(ethyleneoxy)ethyl acrylate) (Monomer-Polymer & Dajak Labs, Inc., Feasterville, Pa.). Negative control microcapsules were made with a Core Solutions containing only TE buffer and glycerin.

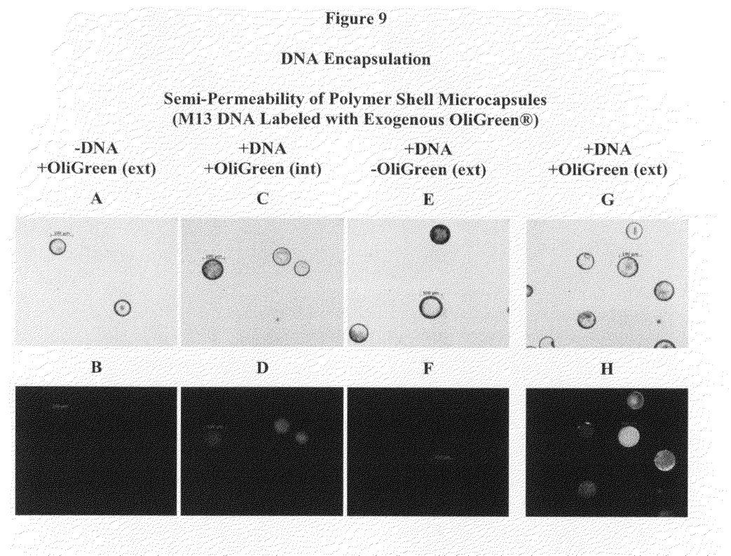

The harvested microcapsules were decanted and rinsed 2× with 20 mL distilled water. Negative control microcapsules without DNA and microcapsules containing the DNA Core Solution were incubated by mixing 100 μL of microcapsule suspension with 40 μL of a 1:20 dilution of OliGreen® in TE buffer. Fluorescence images were taken after 1 hour of incubation in the dark at room temperature, and are provided in FIG. 9. Exposure time for all images: t=5 secs.

There was no observable fluorescence from OliGreen® when added exogenously to negative control microcapsules without DNA. Microcapsules containing 20 μg/mL of single-stranded M13 DNA were brightly stained after incubation for 1 hour in exogenously added OliGreen®, indicating that these microcapsules were preferentially permeable to the lower molecular weight OliGreen® dye while retaining the much higher molecular weight single-stranded M13 DNA. The Molecular Weight Cut Off (MWCO) of the semi-permeable polymer shell membrane of these microcapsules is therefore >1,000 Daltons but <2.4 million Daltons.

### Example 8

DNA amplification in semi-permeable polymer shell microcapsules was demonstrated using hyperbranched Rolling Circle Amplification (RCA). High molecular weight DNA (single-stranded M13mp18 DNA—M_{w} 2.4 MDa, 7,249 bases) was incorporated in microcapsules along with φ29 polymerase, random hexamers as primers, and deoxynucleotide triphosphate mix (dNTP mix). Semi-permeable microcapsules were produced as described in Example 4. All conditions were identical, except for the composition of the Core Solution, which was modified as follows: RCA Mix formulated by combining 13.5 μL diluted single-stranded M13mp18 DNA (1 μg/mL—Sigma-Aldrich, St. Louis, Mo.), 2.125 μL concentrated φ29 polymerase in buffer (New England Biolabs, Ipswich, Mass.), 8.75 μL random hexamer primers in H₂O (New England Biolabs, Ipswich, Mass.), 8.75 μL glycerol (25% v/v—Sigma-Aldrich, St. Louis, Mo.), 3.75 μL 10× RCA buffer (37 mM TRIS-HCl, 50 mM KCl, 10 mM MgCl₂, 5 mM NH₂SO₄, 1 mM DTT (dithiothrietol), 1× BSA), 0.4 μL 10× BSA (bovine serum albumin—New England Biolabs, Ipswich, Mass.) and 3.75 μL dNTP mix (New England Biolabs, Ipswich, Mass.), and the Focusing Fluid, which was composed of 5 wt % PVA in 1× RCA buffer. DNA cannot be visually detected at this low initial concentration in polymer microcapsules.

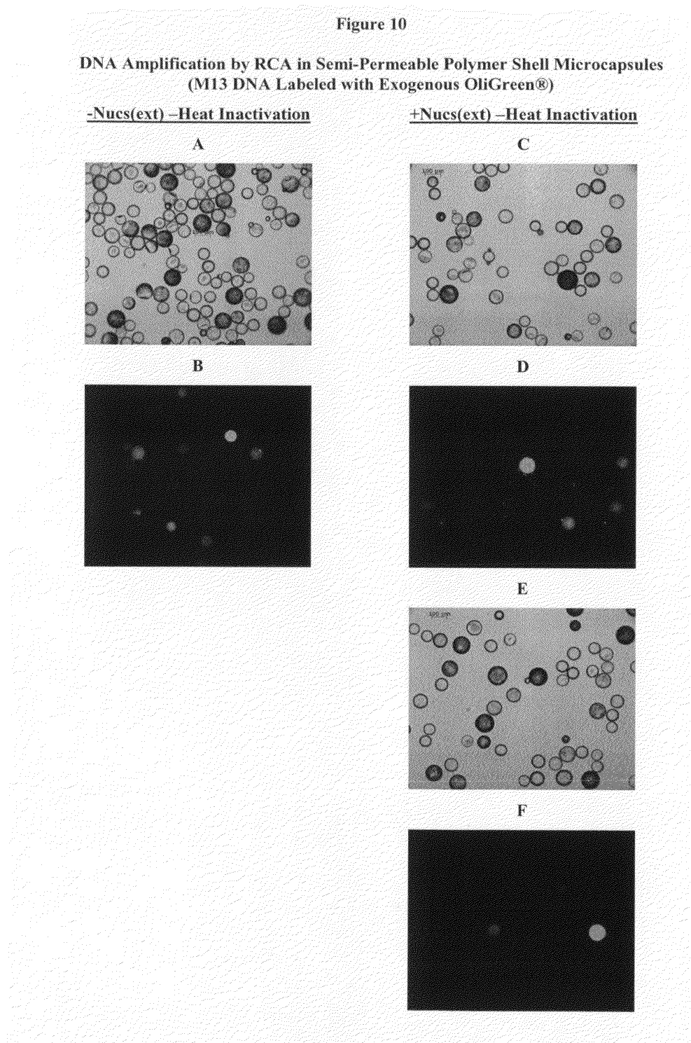

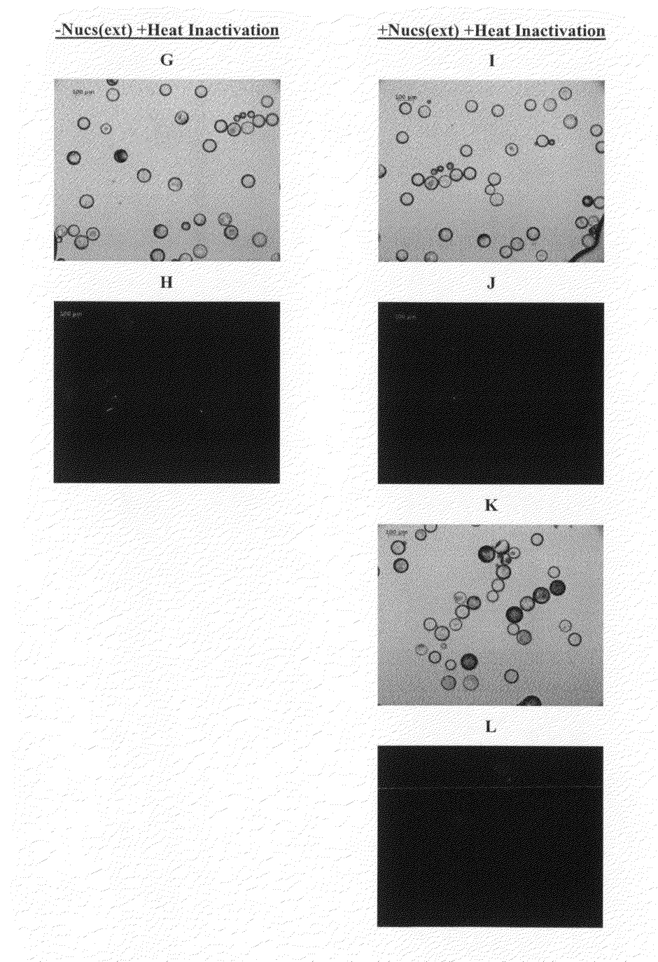

The harvested microcapsules were split into four 100 μL batches in 500 μL Safe-Lock Eppendorf microfuge tubes (Brinkmann Instruments, Inc., Westbury, N.Y.). The first batch was incubated as described below with no further treatment. This polymer microcapsule formulation is known to be permeable to dye molecules that are approximately the same molecular weight as native nucleotides. Therefore, 25 μl dNTP mix was added externally to the second and fourth batches. The third and fourth batches were then subjected to a five minute heat inactivation of the φ29 polymerase at 65° C. The four microfuge tubes containing the microcapsules were incubated at 30° C. for 4 hours in a thermocycler (MiniCycler™—MJ Research, Watertown, Mass.). Following incubation, 100 μL of 2× OliGreen® reagent (Invitrogen/Molecular Probes, Eugene, Oreg.) in 1× TE was added to each tube, incubated for ˜16 hours at room temperature and then imaged with 4 second exposures. Fluorescence images are provided in FIG. 10.

There was no observable fluorescence from OliGreen® when added exogenously to heat-inactivated control microcapsules, either without exogenously added dNTPs (FIGS. 10G-H) or with exogenously added dNTPs (FIGS. 10I-L). However, microcapsules containing all components necessary to support RCA, either without exogenously added dNTPs (FIGS. 10A-B) or with exogenously added dNTPs (FIGS. 10C-F), demonstrated strong fluorescence from exogenously added OliGreen® providing evidence for significant DNA amplification.

### Example 9

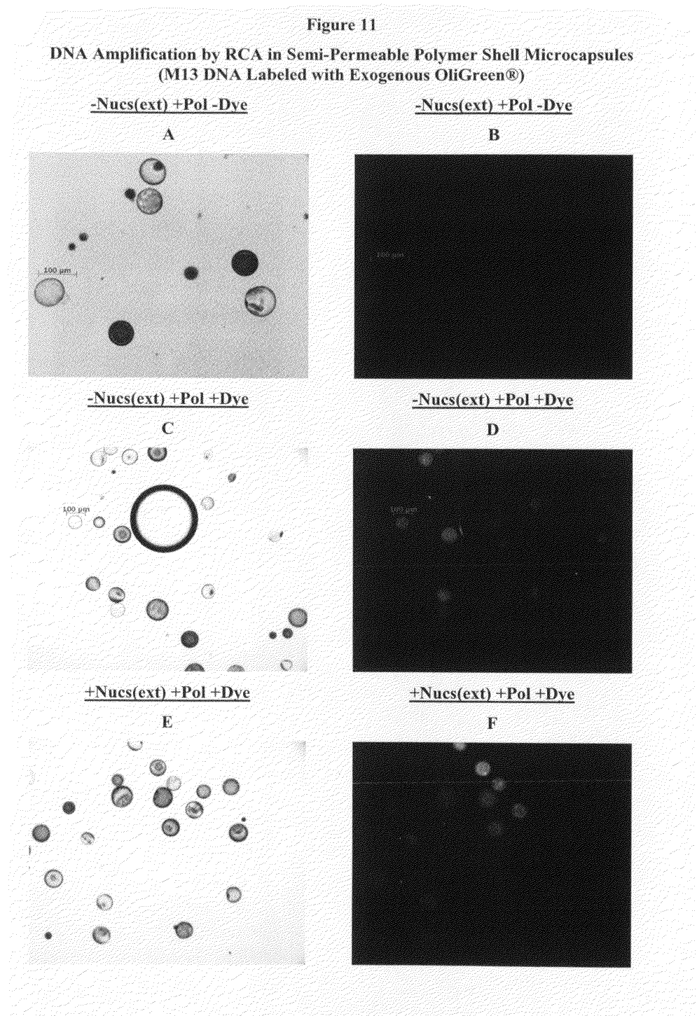

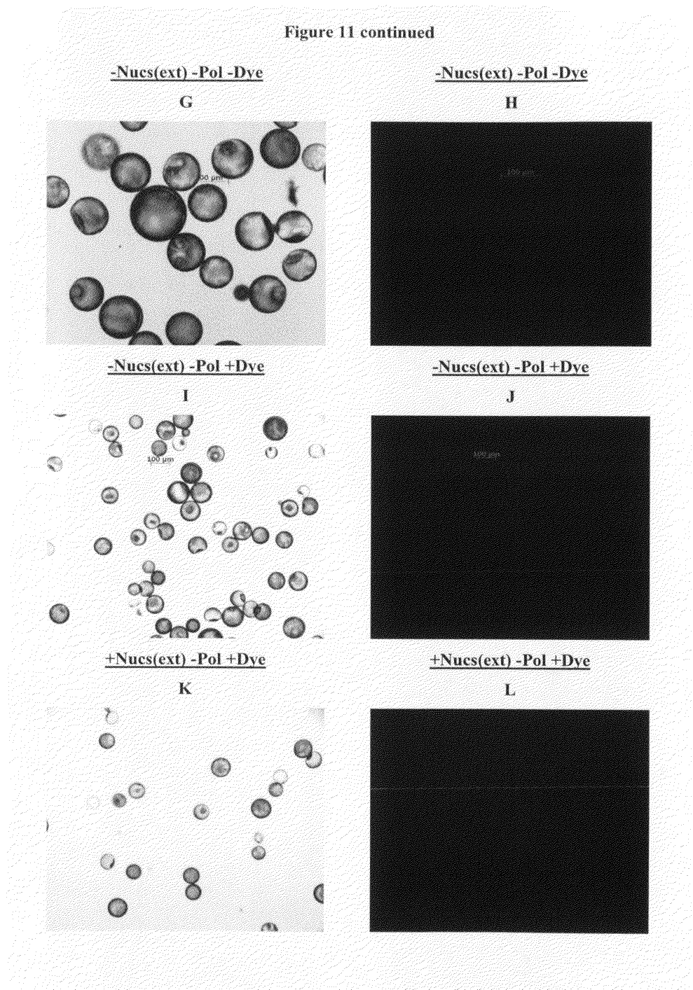

Hyperbranched Rolling Circle Amplification (RCA) was further demonstrated with an alternative polymer shell formulation. Conditions were identical to those in Example 8 except for the composition of the Polymer Shell solution, which was identical to that used in Example 6, except for the ratio of PEGDMA 200 and MPEOEA, which was 10:1 v/v. The microfuge tubes containing the microcapsules were incubated at 35° C. for 10 hours in a thermocycler (MiniCycler™—MJ Research, Watertown, Mass.). Following incubation, 60 μL of 1:20 dilution of OliGreen® reagent (Invitrogen/Molecular Probes, Eugene, Oreg.) in 1× TE was added to each tube, incubated for ˜3 hours at room temperature and then imaged (exposure time=3 sec). Brightfield and fluorescence images are shown in FIG. 11. All control microcapsules lacking polymerase were negative for amplification (G-L). Microcapsules with only internally added nucleotides (C-D), as well as those with both internally and externally added nucleotides (E-F), both show clear evidence of DNA amplification, with somewhat higher integrated fluorescence intensity in the latter batch indicating a higher degree of amplification.

### Example 10

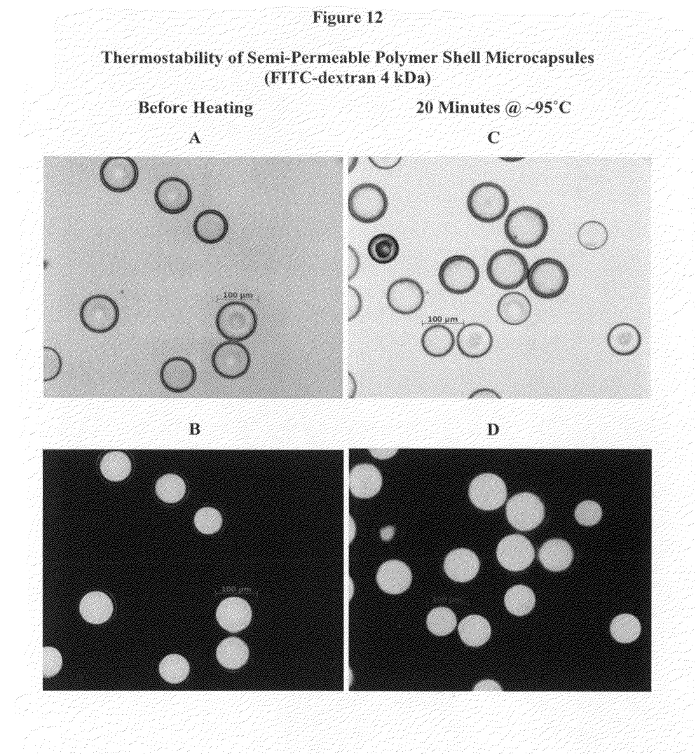

Thermostability of semi-permeable polymer shell microcapsules was demonstrated by producing FITC-labeled dextran (4 kDa) loaded microcapsules as described in Example 5. The harvested microcapsules were rinsed in distilled water and imaged ˜5 minutes after they were created. The microcapsules were then heated to ˜95° C. in distilled water for 20 minutes, cooled to room temperature and reimaged. Brightfield and fluorescence images are provided in FIG. 12.

There was no observable loss of fluorescence or change in the morphology of the microcapsules after heating, indicating that they are sufficiently thermostable to withstand conditions for PCR and/or cycle sequencing.

### Example 11

Permeability of the alternative formulation polymer shell microcapsules to dye-labeled dideoxynucleotide terminators was demonstrated using conditions identical to those in Example 7 except for the composition of the Core Solution, which was 25% v/v glycerol. Impermeable microcapsules were used as controls.

5 μL of suspended microcapsules were mixed with 5 μL of dye-labeled dideoxynucleotide terminators (tetramethyl rhodamine-ddTTP, Thermo Sequenase Dye Terminator Cycle Sequencing Core Kit, Amersham Biosciences, Piscataway, N.J.) and incubated at room temperature in the dark for 3 hours.

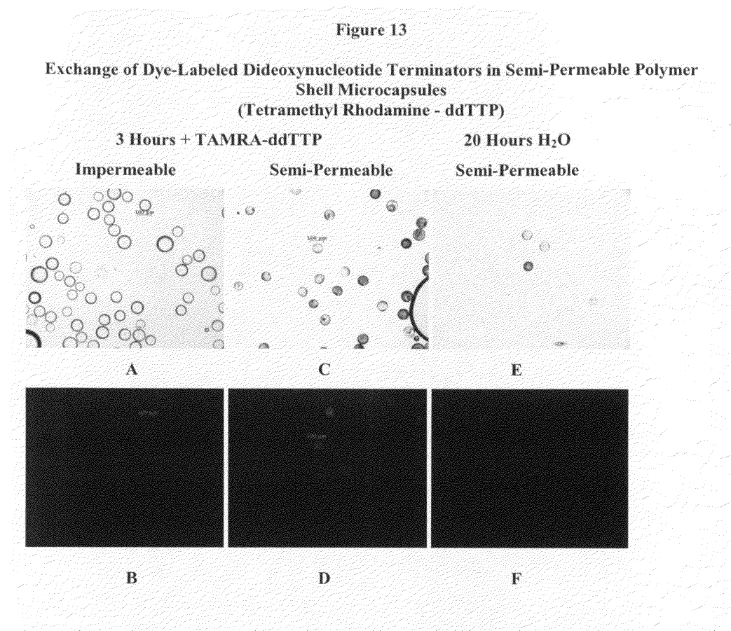

Microcapsules were then washed with 2 mL distilled H₂O and imaged immediately. Microcapsules were allowed to incubate in distilled H2O for an additional 20 hours in the dark and imaged again as shown in FIG. 13.

The aqueous cores of the impermeable PEGDMA microcapsules were non-fluorescent after 3-hour incubation in dye-labeled ddTTP, whereas the aqueous cores of the semi-permeable PEGDMA-MPEOEA microcapsules show significant internal fluorescence. The process is reversible, as indicated by the loss of internal fluorescence upon further incubation in water, indicating that dye-labeled dideoxynucleotide terminators can freely exchange across the semi-permeable polymer shell membrane of these microcapsules.

What is claimed is:

1. A device for continuous imaging of nucleic acids, the device comprising: a rotating drum, wherein an exterior surface of the drum comprises a plurality of color sensitive pixels.

2. The device according to claim 1, wherein each pixel comprises at least one photodiode and at least one thin film transistor.

3. The device according to claim 1, further comprising readout circuitry connected to the pixels by at least one electrode.

4. The device according to claim 1, wherein each pixel on the exterior surface of the drum is capable of detecting colors within the visible and infrared light spectrum.

5. The device according to claim 4, wherein each pixel is capable of detecting at least four different colors within the visible and infrared light spectrum, at least eight different colors within the visible and infrared light spectrum, and at least about sixteen different colors within the visible and infrared light spectrum.

6. A system for continuous imaging of nucleic acids, the system comprising:
a conveyance apparatus for conveying an electrophoresis gel containing nucleic acids along a conveying path;
a device that removes a first top film from the electrophoresis gel, exposing a top surface of the electrophoresis gel;
at least one fixing reservoir connected to the conveyance apparatus, wherein the fixing reservoir is configured such that at least one fixing solution is in fluid contact with the electrophoresis gel being conveyed along the conveying path;
a dryer device connected to the conveyance apparatus;
a coating apparatus that applies peroxyoxalate chemiluminescent chemistry reagents and a second top film to the exposed top surface of the electrophoresis gel; and
an imager connected to the conveyance apparatus comprising a rotating drum, wherein an exterior surface of the drum comprises a plurality of color sensitive pixels, wherein the imager is configured such that the second top film of the electrophoresis gel is in contact with the color sensitive pixels as the electrophoresis gel is being conveyed along the conveying path.

7. The system according to claim 6, wherein the coating apparatus comprises a first horizontally oriented roller and a second counter-rotating horizontally oriented roller, wherein the first and second rollers are configured such that a slot is formed between the rollers, wherein the electrophoresis gel is conveyed over the first roller, and wherein a second top film is conveyed over the second roller; wherein the apparatus further comprises a distribution channel connected to a reservoir, a pump that dispense the peroxyoxalate chemiluminescent chemistry reagents onto the exposed top surface of the electrophoresis gel prior to the electrophoresis gel reaching the first roller.

8. The system according to claim 6, wherein the coating apparatus comprises a plurality of printing and laminating apparatuses, wherein a first printing apparatus applies a first component of the peroxyoxalate chemiluminescent chemistry reagents to the exposed top surface of the electrophoresis gel, a second printing apparatus applies a second component of the peroxyoxalate chemiluminescent chemistry reagents onto the exposed top surface of the electrophoresis gel and at least one laminating apparatus then applies a second top film to the exposed surface of electrophoresis gel.

9. The system according to claim 6, further comprising at least one computer operably connected to the continuous electrophoresis system.

10. The system according to claim 6, wherein the peroxyoxalate chemiluminescent chemistry reagents comprise a saturated oxalate solution, a concentrated hydrogen peroxide solution, and at least one fluorescent dye attached to the nucleic acid.

11. The system according to claim 6, wherein the fixing solutions are selected from the group consisting of acetic acid, propionic acid, succinic acid, tartaric acid, citric acid, methanol, ethanol, n-propanol, isopropanol, iso-butyl alcohol, sec-butyl alcohol and tert-butyl alcohol.

12. The system according to claim 6, wherein each pixel comprises at least one photodiode and at least one thin film transistor.

13. The system according to claim 12, further comprising readout circuitry connected to the pixels by at least one electrode.

14. The system according to claim 6, wherein each pixel on the exterior surface of the drum of the imager is capable of detecting colors within the visible and infrared light spectrum.

15. The system according to claim 14, wherein each pixel of the imager is capable of detecting at least four different colors within the visible and infrared light spectrum, at least eight different colors within the visible and infrared light spectrum, and at least sixteen different colors within the visible and infrared light spectrum.

16. A method for continuous imaging of nucleic acids, the method comprising:
removing a first top film of an electrophoresis gel containing the nucleic acids, exposing a top surface of the electrophoresis gel, as the electrophoresis gel is being conveyed along a conveying path;
fixing the nucleic acids and drying the electrophoresis gel;
applying peroxyoxalate chemiluminescent chemistry reagents and a second top film to the exposed top surface of the electrophoresis gel; and
imaging the nucleic acids.

17. The method according to claim 16, wherein applying the peroxyoxalate chemiluminescent chemistry reagents and a second top film is performed by a coating and laminating apparatus.

18. The method according to claim 16, wherein fixing comprises contacting the exposed top surface of the electrophoresis gel with at least one fixing solution, as the electrophoresis gel is being conveyed along the conveying path.

19. The method according to claim 18, wherein the fixing solutions are selected from the group consisting of acetic acid, propionic acid, succinic acid, tartaric acid, citric acid, methanol, ethanol, n-propanol, isopropanol, iso-butyl alcohol, sec-butyl alcohol and tert-butyl alcohol.

20. The method according to claim 16, wherein the peroxyoxalate chemiluminescent chemistry reagents comprise a saturated oxalate solution, a concentrated hydrogen peroxide solution, and at least one fluorescent dye attached to the nucleic acid.

21. The method according to claim 17, wherein imaging comprises contacting the second top film of the electrophoresis gel to an exterior surface of a rotating drum, wherein the exterior surface of the drum comprises a plurality of color sensitive pixels.

22. The method according to claim 21, wherein each pixel comprises at least one photodiode and at least one thin film transistor.

23. The method according to claim 22, further comprising readout circuitry connected to the pixels by at least one electrode.

24. The method according to claim 17, wherein each pixel on the exterior surface of the drum is capable of detecting colors within the visible and infrared light spectrum.

25. A method of sequencing DNA, comprising:
conducting a sequencing reaction in a microcapsule;
applying the microcapsule and a first polymer matrix onto a base film to form an electrophoresis gel that is being continuously conveyed along a conveying path;
conducting electrophoretic separation; and
imaging the nucleic acids, wherein imaging comprises contacting a top film of the electrophoresis gel to an exterior surface of a rotating drum, wherein the exterior surface of the drum comprises a plurality of color sensitive pixels.

26. A device for continuous imaging of nucleic acids, the device comprising: a rotating drum, wherein an exterior surface of the drum comprises a plurality of slits and a plurality of color sensitive pixels, wherein an interior of the drum comprises at least one light source configured to emit light through the slits in the exterior surface of the drum.

27. The device according to claim 26, further comprising at least one light source connected to at least one edge of the rotating drum.

28. The device according to claim 26, wherein the light source is selected from a lamp, a laser, and an LED.

29. The device according to claim 26, wherein each pixel comprises at least one photodiode and at least one thin film transistor.

30. The device according to claim 29, further comprising readout circuitry connected to the pixels by at least one electrode.

31. The device according to claim 1, wherein each pixel on the exterior surface of the drum is capable of detecting colors within the visible and infrared light spectrum.

32. The device according to claim 31, wherein each pixel is capable of detecting at least four different colors within the visible and infrared light spectrum, at least eight different colors within the visible and infrared light spectrum, and at least about sixteen different colors within the visible and infrared light spectrum.
